(19) United States
(12) Patent Application Publication
(10) Pub. No.: US 2006/0241098 A1
(43) Pub. Date: Oct. 26, 2006

(54) Pesticidal n-substituted azacyclic derivatives

(76) Inventors: Syed F. Ali, Yardville, NJ (US); Stephen F. Donovan, Revere, PA (US); Leo B. Dungan, Lumberton, NJ (US); David M. Roush, Princeton, NJ (US); George Theodoridis, Princeton, NJ (US); Thomas M. Zydowsky, Brooklyn, NY (US); Rao S. Bhandaru, Belle Mead, NJ (US)

Correspondence Address: Paul A Fair;FMC Corporation, 1735 Market Street, Philadelphia, PA, 19103, US

(21) Appl. No.: 10/563,733

(22) PCT Filed: Jul. 1, 2004
(86) PCT No.: PCT/US04/21314

§ 371 Date: May 15, 2006

Related U.S. Application Data
(60) Provisional application No. 60/485,297, filed on Jul. 7, 2003.

(51) Int. Cl. A01N 43/00; A01N 43/54; A01N 43/40; A01N 43/90

(52) U.S. Cl. 514/214.01; 514/304; 514/256; 514/305; 514/341; 514/235.2

(57) ABSTRACT

Pesticidal compositions comprising a pesticidally effective amount of an N-substituted azacyclic derivative of the formula (I); wherein R, an N-substituted azacycle, and V, Q, X, T and U are defined, as well as their agriculturally acceptable salts, in admixture with at least one agriculturally acceptable extender or adjuvant are disclosed. In addition, methods of controlling pests such as insects and acarids comprising applying said compositions to a locus of crops where control is desired are disclosed.

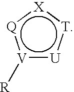

This application claims the benefit of U.S. Provisional Application No. 60/485,297, filed Jul. 7, 2003.

### FIELD OF THE INVENTION

The present invention relates to methods for controlling pests. In particular, it relates to control by the application of certain novel compositions containing pesticidal N-substituted azacyclic derivatives.

### BACKGROUND OF THE INVENTION

It is well known that pests such as insects and acarids in general can cause significant damage, not only to crops grown in agriculture, but also, for example, to structures and turf where the damage is caused by soil-borne insects, such as termites and white grubs. Such damage may result in the loss of millions of dollars of value associated with a given crop, turf or structure. Insecticides and acaricides are useful for controlling insects and acarids which may otherwise cause significant damage to crops such as wheat, corn, soybeans, potatoes, and cotton to name a few. For crop protection, insecticides and acaricides are desired which can control the insects and acarids without damaging the crops, and which have no deleterious effects to mammals and other living organisms. Surprisingly, it has now been found that compositions of N-substituted azacyclic derivatives of the present invention are unexpectedly active in controlling sucking pests such as cotton aphids, as well as other insect species.

Pharmacologically active 1,2,4-, 1,3,4-, and 1,2,5-oxadiazoles and 1,2,4-, 1,3,4- and 1,2,5-thiadiazoles have been reported in the literature, for example, Wätjen et al., U.S. Pat. No. 4,870,073; Baker et al., U.S. Pat. Nos. 4,952,587 and 5,686,463 and European Patent EP 0323864 A2; Sauerberg et al., U.S. Pat. Nos. 5,260,314, 5,481,240 and 5,527,813; Sauerberg et al., Journal of Medicinal Chem., Vol. 35, No. 12, pp. 2274-2283 (1992); Olesen et al., Eur. J. Med. Chem., 31, pp. 221-230 (1996); and MacLeod et al., Journal of Medicinal Chem., Vol. 33, pp. 2052-2059 (1990). Similarly, insecticidally and acaricidally active 1,2,4-, 1,3,4-, and 1,2,5-oxadiazoles, 1,2,3-, 1,2,4- and 1,3,4-thiadiazoles, 1,2,4-triazoles, and 1,2,3,4-tetrazoles have been reported in the literature. For example, Dick, U.S. Pat. No. 5,393,767; Tsubata et al., U.S. Pat. Nos. 6,337,341 B1 and 6,348,460 B1; Theobald et al., U.S. Pat. No. 4,943,584; and Matsumoto et al., U.S. Pat. No. 4,722,934. EP 0445731 A1 and WO 01/15532 disclose azabicyclo and azacyclo oxime and amine compounds as pesticides. It has also been disclosed that pharmacologically active 1,2,4- and 1,2,5-thiadiazoles and insecticidally and acaricidally active 1,2,4-oxdiazoles, 1,3,4-triazoles, and 1,2,3,4-tetrazoles can act as muscarinic agonists, see, for example, Sauerberg et al., Journal of Medicinal Chem., Vol. 35, No. 12, pp. 2274-2283 (1992); Dick et al., Pestic. Sci., 49, 268-276 (1997); Olesen et al., Eur. J. Med. Chem., 31, pp. 221-230 (1996); and MacLeod et al., Journal of Medicinal Chem., Vol. 33, pp. 2052-2059 (1990).

WO 95/03306 discloses arthropodically active substituted 1,2,5-oxadiazoles and 1,2,5-thiadiazoles; however, it specifically requires that the 1,2,5-oxadiazole or 1,2,5-thiadiazole be substituted with an azabicyclic compound rather than a tetrahydropyridyl or a pyridyl ring and that said azabicyclic compound can only attach at the two position when the bridge occurs between the nitrogen and a carbon atom on the ring.

WO 93/14636 and its equivalent U.S. Pat. No. 5,244,906 disclose certain substituted 1,2,4-oxadiazoles and 1,2,4-thiadiazoles useful for control of insects, such as sucking insects like two-spotted spider mite.

### SUMMARY OF THE INVENTION

It has now been found that certain compositions containing a pesticidally effective amount of an N-substituted azacyclic derivative, and their agriculturally acceptable salts, in admixture with at least one agriculturally acceptable extender or adjuvant are surprisingly effective in controlling pests, i.e., acaricides, as well as insects. The N-substituted azacyclic derivatives may be represented by the following formula I: 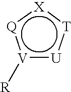
wherein
R is an azacycle selected from the following: 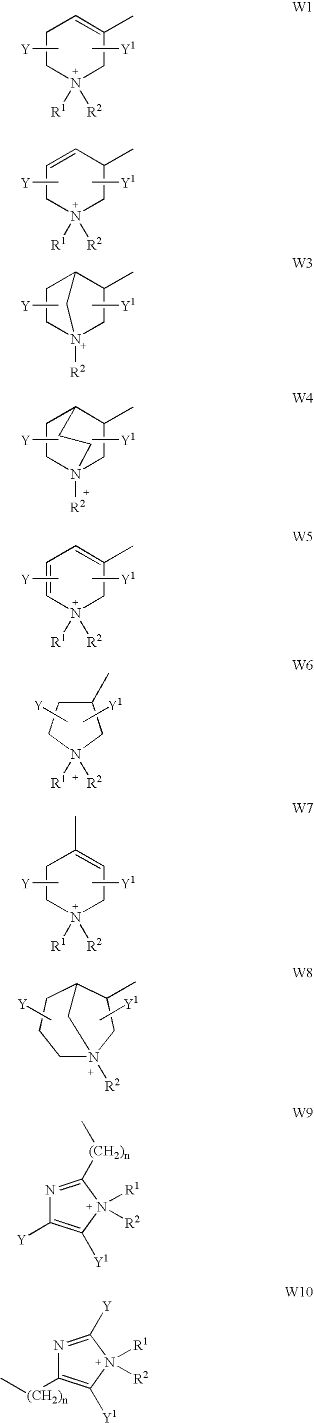 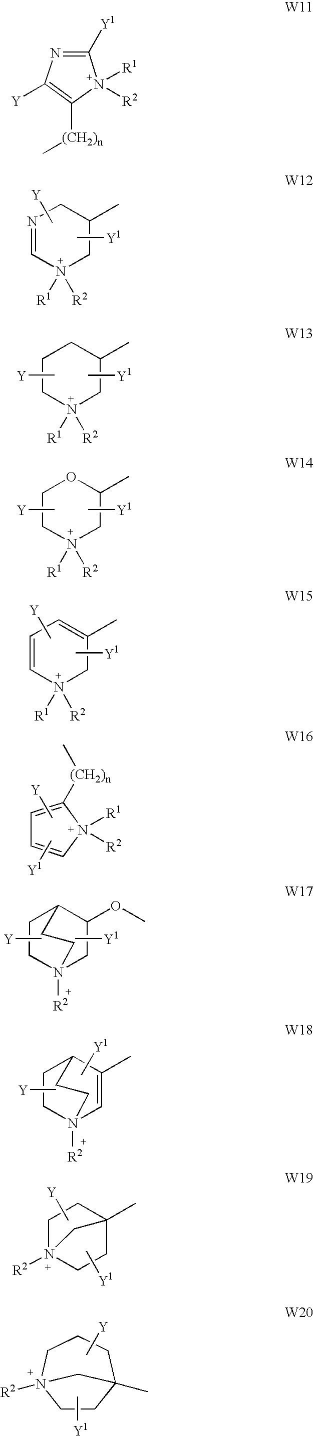 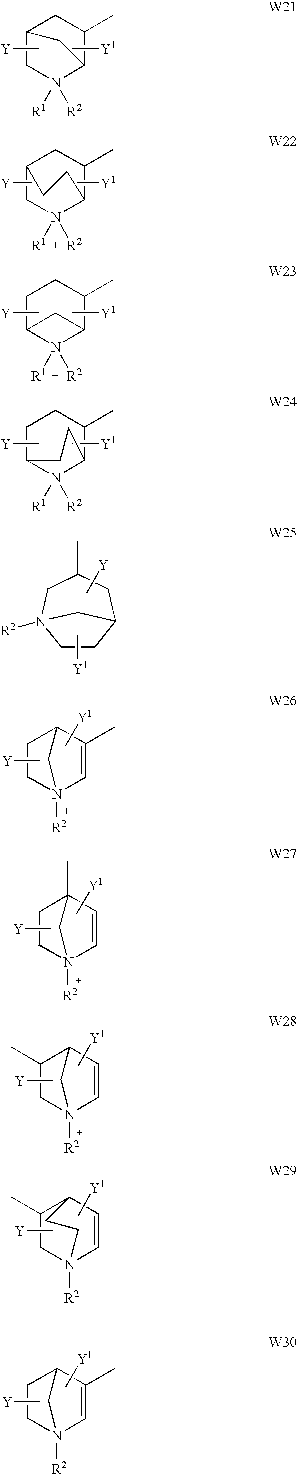 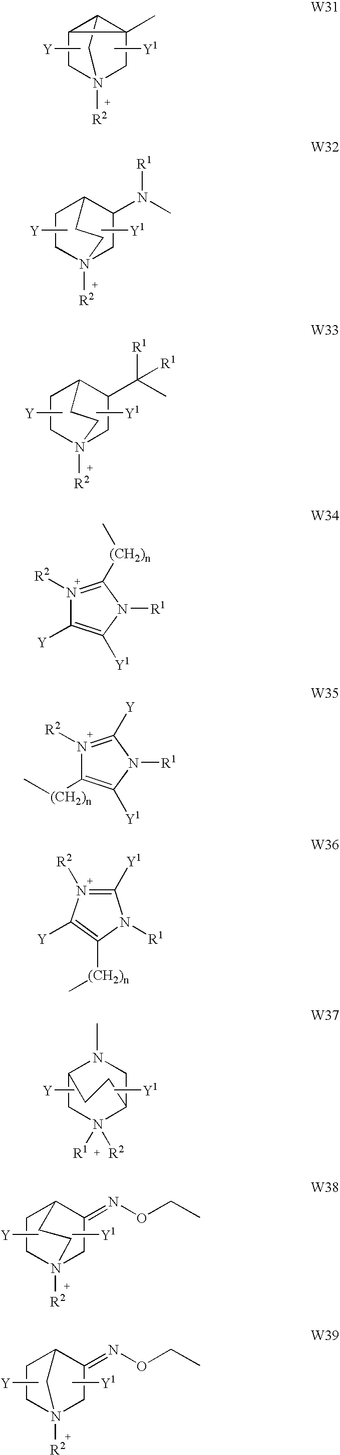 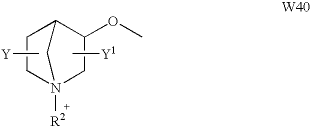
   where
Y and Y¹ may be attached at the same or different positions, and are independently selected from hydrogen, halogen, hydroxy, cyano, nitro, amino, carboxyl, alkyl, haloalkyl, alkenyl, alkoxy, haloalkoxy, aminoalkoxy, alkylcarbonyl, haloalkylcarbonyl, alkoxycarbonyl, haloalkoxycarbonyl, arylalkyl, aryl, aryloxy, and heterocyclyl, where the aryl and heterocyclyl moieties may be optionally substituted with halogen, alkyl, haloalkyl, alkoxy, or haloalkoxy;
R¹ is selected from alkyl, haloalkyl, alkenyl, haloalkenyl, alkynyl, arylalkyl, and aryl; wherein the aryl may be optionally substituted with halogen, alkyl, haloalkyl, alkoxy, or haloalkoxy;
R² is selected from O⁻, forming an N-oxide; alkyl, alkoxy, haloalkyl, alkenyl, haloalkenyl, haloalkoxy, alkylcarbonyloxy, alkoxycarbonylalkyl, ⁻Ocarbonylalkyl, alkylthioalkyloxy, alkylsulfinylalkyloxy, alkylsulfonylalkyloxy, alkoxyphosphonylalkyloxy, ⁻Ophosphonylalkyloxy, alkoxyalkyl, arylalkyl, arylalkyloxy, arylcarbonyloxy, arylalkoxycarbonyloxy arylalkylcarbonyloxy, aryl, —OC(O)N(R³)(R⁴); wherein the aryl may be optionally substituted with halogen, alkyl, haloalkyl, alkoxy, or haloalkoxy moiety;
   where
   R³ and R⁴ are independently selected from hydrogen, alkyl, alkylcarbonyl, alkoxycarbonyl, alkoxyalkyl, aminoalkyl, aryl, arylalkyl, and carbonylamino; where the aryl may be optionally substituted with halogen, alkyl, haloalkyl, alkoxy, cyano, or haloalkoxy; and, 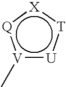
      is a 5-membered heterocycle, wherein V is carbon or nitrogen; Q is carbon, nitrogen or oxygen; X is carbon, nitrogen, oxygen or sulfur, T is carbon, nitrogen, oxygen or C(═O); and U is carbon, nitrogen, oxygen or sulfur, wherein said 5-membered heterocycle is selected from the following; 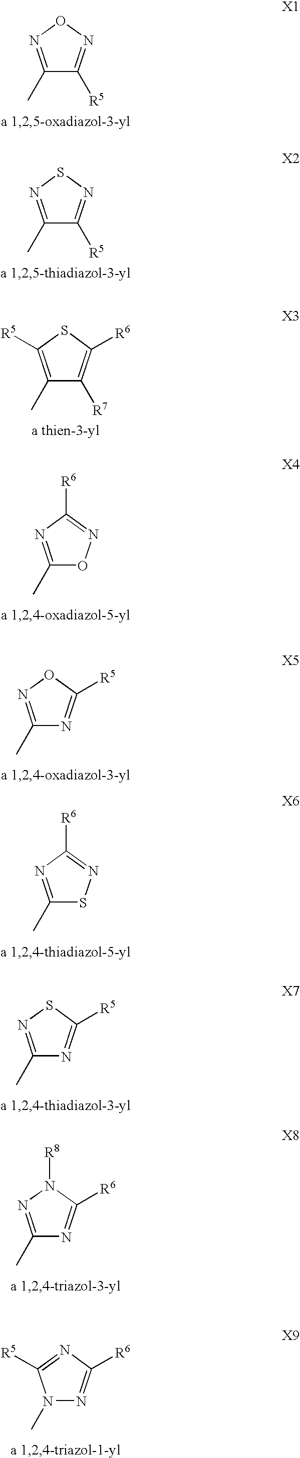 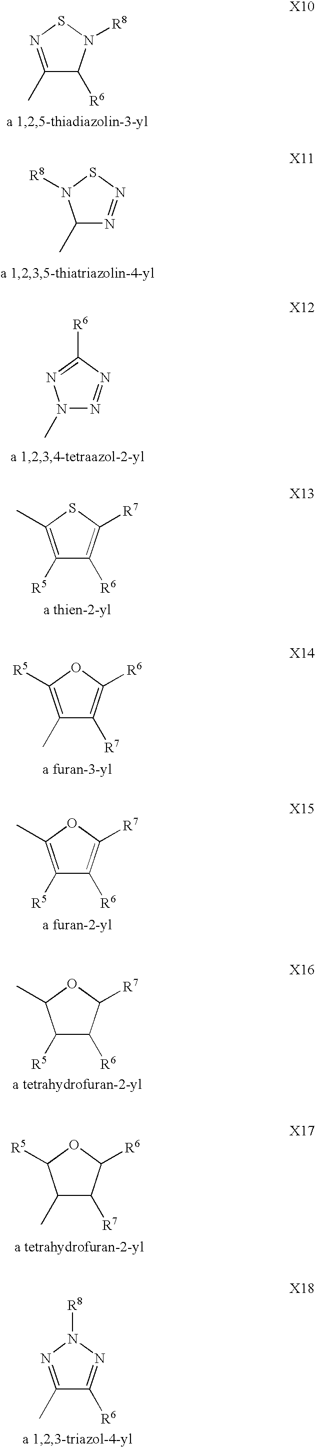 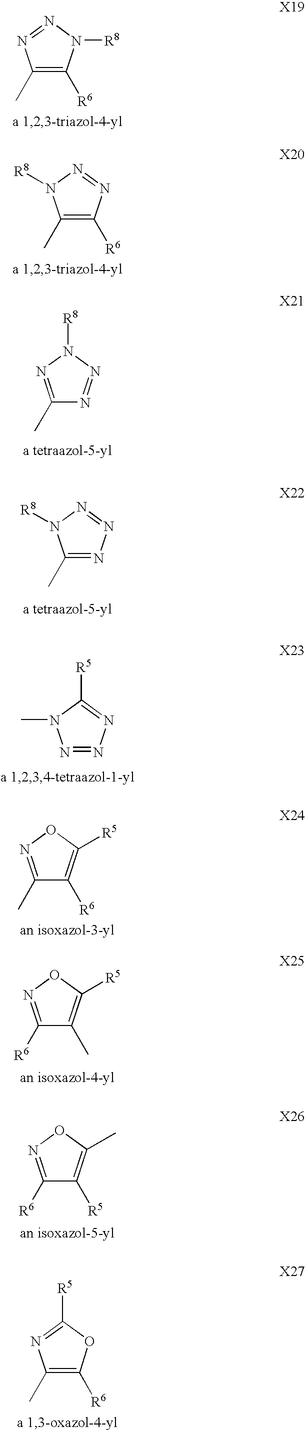 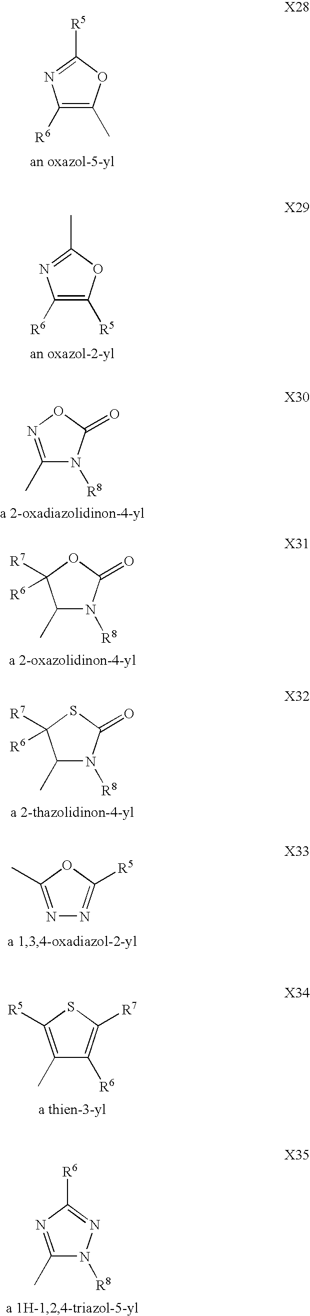
      where
R⁵, R⁶ and R⁷ are independently selected from hydrogen; hydroxy; hydroxyalkyl, aminoalkyl, halogen; amino; nitro; alkynyl; haloalkynyl; alkoxy; alkoxyalkyl, haloalkoxy; aryl, arylalkyloxy, alkenyloxy; alkynyloxy; thiol; alkylthio; haloalkylthio; cyanoalkylthio; alkenylthio; alkynylthio; alkoxythio, carboxyl, formyl; alkyloxycarbonyl; carboxyl; —N(R⁹)(R¹⁰); —NHN(R⁹)(R¹⁰); —NHC(O)R⁹; —NHC(O)OR⁹; —OC(O)R⁹; where the aryl may be optionally substituted with halogen, alkyl, haloalkyl, alkoxy, cyano, or haloalkoxy;
   where
   R⁸ is selected from alkyl, haloalkyl, arylalkyl, alkoxy, alkenyl, haloalkenyl, alkynyl, haloalkynyl,
      where
   R⁹ and R¹⁰ are independently selected from hydrogen, alkyl, alkenyl, alkynyl, alkylthio, alkylcarbonyl, alkoxycarbonyl, aryl, arylalkyl, and carbonylamino; where the aryl may be optionally substituted with halogen, alkyl, haloalkyl, alkoxy, cyano, or haloalkoxy; and
      the corresponding agriculturally acceptable salts thereof.

The present invention is also directed to methods of controlling pests, such as insects and acarids, where control is desired, which comprises applying a pesticidally effective amount of the above composition to a locus of crops, or other areas where pests are present or are expected to be present.

### DETAILED DESCRIPTION OF THE INVENTION

In one aspect, the present invention relates to compositions containing a pesticidally effective amount of an N-substituted azacyclic derivative and their agriculturally acceptable salts, in admixture with at least one agriculturally acceptable extender or adjuvant which are surprisingly effective as pesticides, i.e., as acaricides and insecticides. Generally, the N-substituted azacyclic derivatives may be represented by the following formula I: 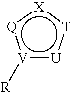
wherein
R is an azacycle selected from the following: 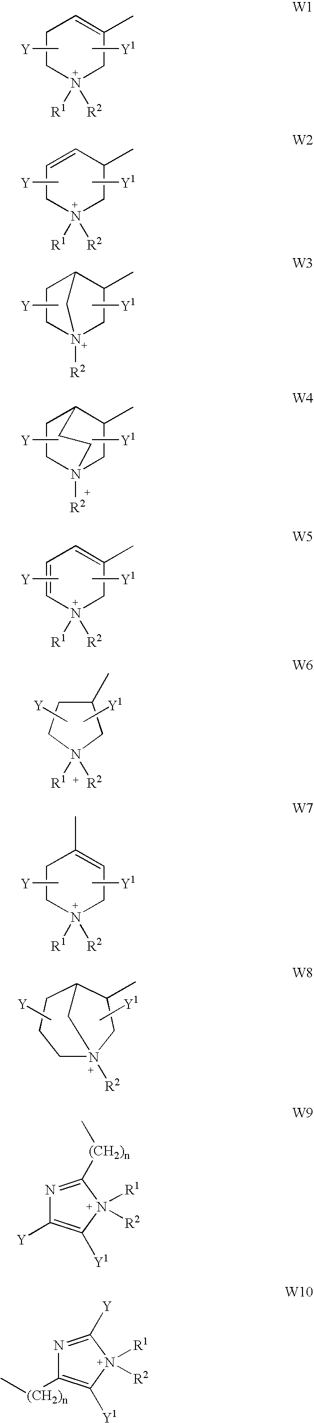 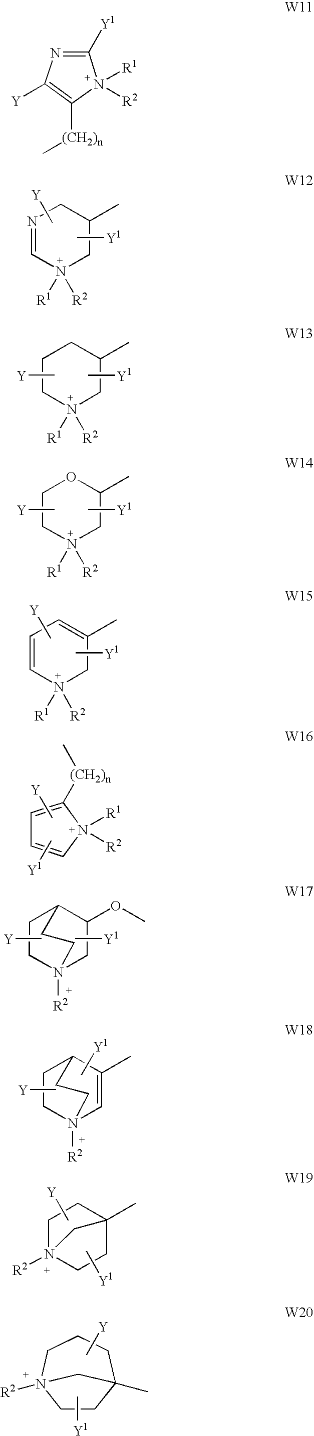 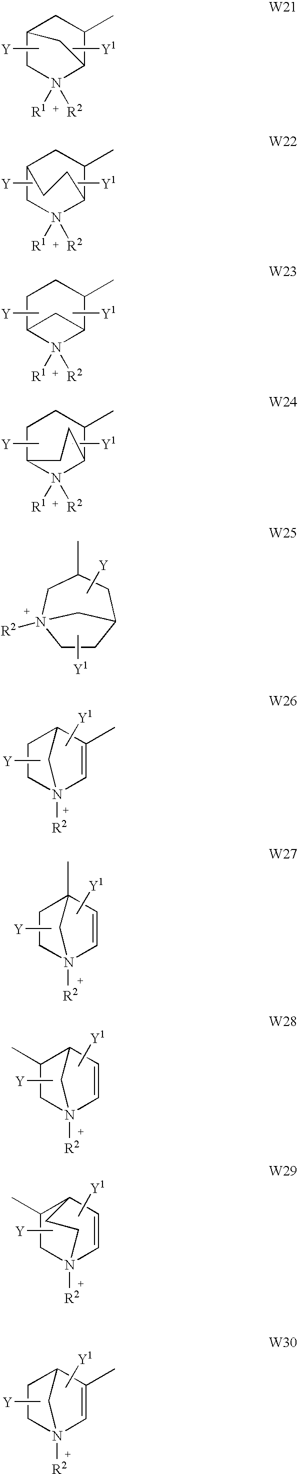 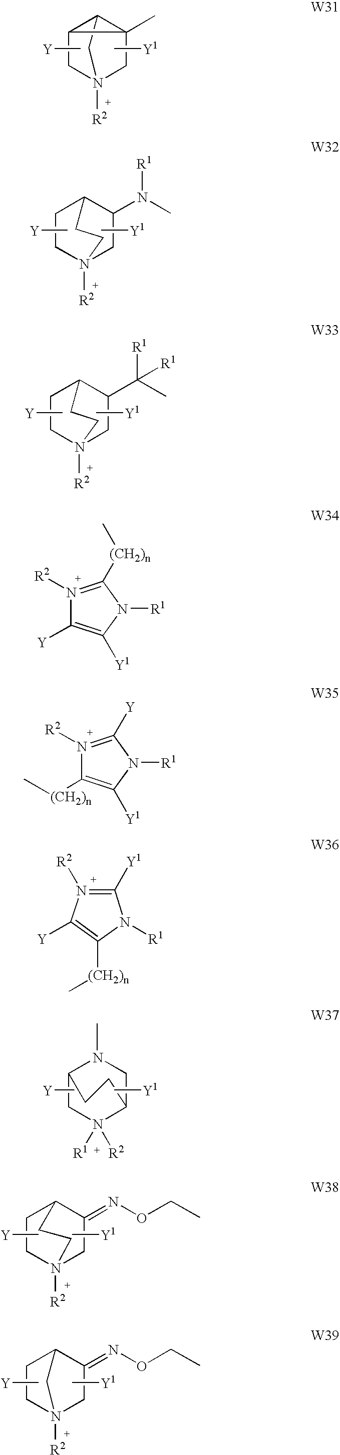 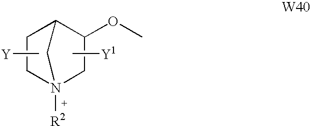
   where
Y and Y¹ may be attached at the same or different positions, and are independently selected from hydrogen, halogen, hydroxy, cyano, nitro, amino, carboxyl, alkyl, haloalkyl, alkenyl, alkoxy, haloalkoxy, aminoalkoxy, alkylcarbonyl, haloalkylcarbonyl, alkoxycarbonyl, haloalkoxycarbonyl, arylalkyl, aryl, aryloxy, and heterocyclyl, where the aryl and heterocyclyl moieties may be optionally substituted with halogen, alkyl, haloalkyl, alkoxy, or haloalkoxy;
R¹ is selected from alkyl, haloalkyl, alkenyl, haloalkenyl, alkynyl, arylalkyl, and aryl; wherein the aryl may be optionally substituted with halogen, alkyl, haloalkyl, alkoxy, or haloalkoxy;
R² is selected from O⁻, forming an N-oxide; alkyl, alkoxy, haloalkyl, alkenyl, haloalkenyl, haloalkoxy, alkylcarbonyloxy, alkoxycarbonylalkyl, ⁻Ocarbonylalkyl, alkylthioalkyloxy, alkylsulfinylalkyloxy, alkylsulfonylalkyloxy, alkoxyphosphonylalkyloxy, ⁻Ophosphonylalkyloxy, alkoxyalkyl, arylalkyl, arylalkyloxy, arylcarbonyloxy, arylalkoxycarbonyloxy arylalkylcarbonyloxy, aryl, —OC(O)N(R³)(R⁴); wherein the aryl may be optionally substituted with halogen, alkyl, haloalkyl, alkoxy, or haloalkoxy moiety;
   where
   R³ and R⁴ are independently selected from hydrogen, alkyl, alkylcarbonyl, alkoxycarbonyl, alkoxyalkyl, aminoalkyl, aryl, arylalkyl, and carbonylamino; where the aryl may be optionally substituted with halogen, alkyl, haloalkyl, alkoxy, cyano, or haloalkoxy; and, 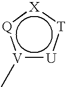
      is a 5-membered heterocycle, wherein V is carbon or nitrogen; Q is carbon, nitrogen or oxygen; X is carbon, nitrogen, oxygen or sulfur, T is carbon, nitrogen, oxygen or C(═O); and U is carbon, nitrogen, oxygen or sulfur, wherein said 5-membered heterocycle is selected from the following; 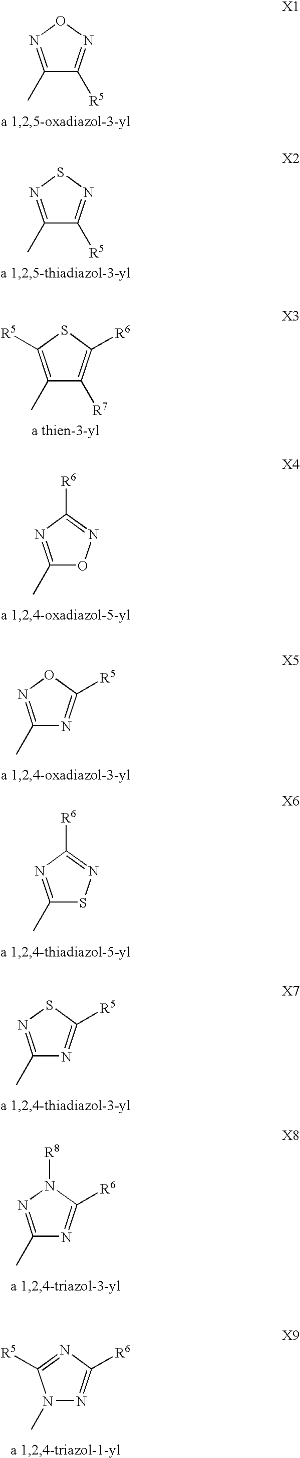 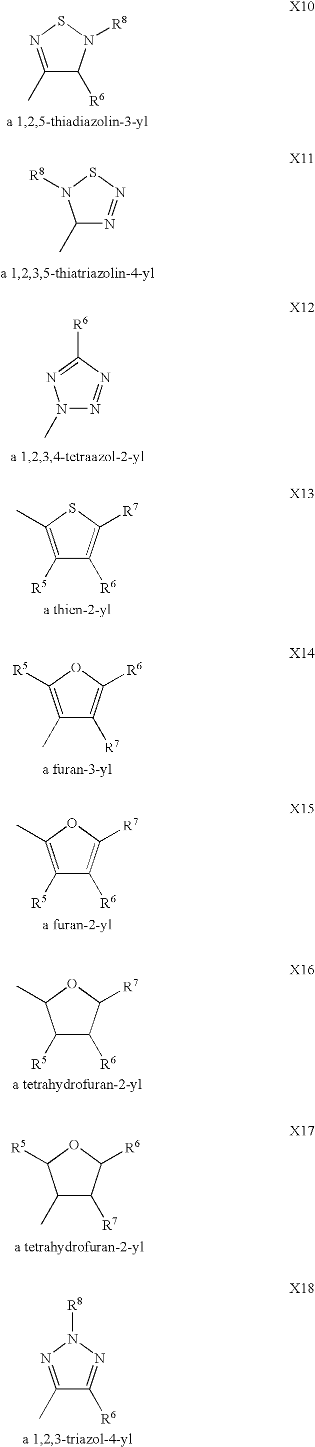 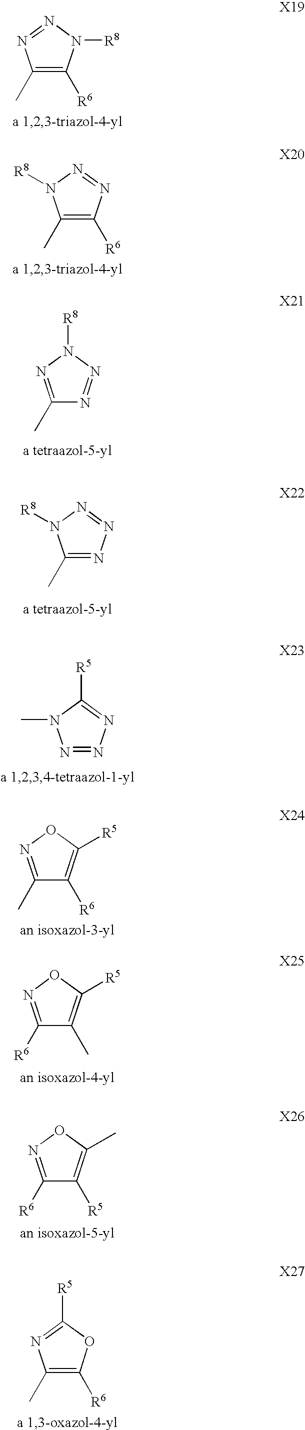 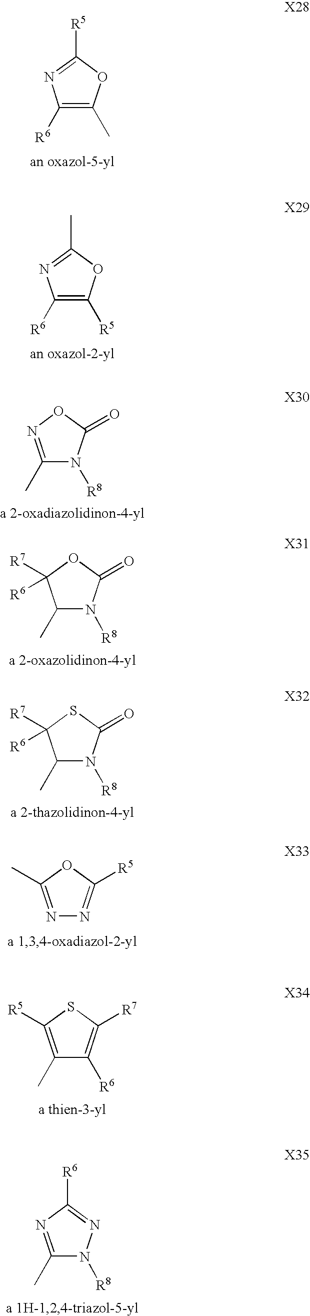
      where
R⁵, R⁶ and R⁷ are independently selected from hydrogen; hydroxy; hydroxyalkyl, aminoalkyl, halogen; amino; nitro; alkynyl; haloalkynyl; alkoxy; alkoxyalkyl, haloalkoxy; aryl, arylalkyloxy, alkenyloxy; alkynyloxy; thiol; alkylthio; haloalkylthio; cyanoalkylthio; alkenylthio; alkynylthio; alkoxythio, carboxyl, formyl; alkyloxycarbonyl; carboxyl; —N(R⁹)(R¹⁰); —NHN(R⁹)(R¹⁰); —NHC(O)R⁹; —NHC(O)OR⁹; —OC(O)R⁹; where the aryl may be optionally substituted with halogen, alkyl, haloalkyl, alkoxy, cyano, or haloalkoxy;
   where
   R⁸ is selected from alkyl, haloalkyl, arylalkyl, alkoxy, alkenyl, haloalkenyl, alkynyl, haloalkynyl,
      where
   R⁹ and R¹⁰ are independently selected from hydrogen, alkyl, alkenyl, alkynyl, alkylthio, alkylcarbonyl, alkoxycarbonyl, aryl, arylalkyl, and carbonylamino; where the aryl may be optionally substituted with halogen, alkyl, haloalkyl, alkoxy, cyano, or haloalkoxy; and
      the corresponding agriculturally acceptable salts thereof.

Agriculturally acceptable salts of the N-substituted azacyclic derivatives of the present invention include, without limitation, iodide and bromide salts and the salts of hydrochloric acid, hydrobromic acid, hydroiodic acid, ethanesulfonic acid, trifluoroacetic acid, methylbenzenesulfonic acid, phosphoric acid, gluconic acid, pamoic acid, and carboxylic acid.

Preferred compositions comprised of the N-substituted azacyclic derivatives of the present invention, selected from those set forth above, are those where R is selected from W1, W3, W4, W8, W13 and W20;
Y and Y¹ are independently selected from hydrogen and halogen;
R¹ is selected from alkyl, haloalkyl, alkoxyalkyl, arylalkyl, alkenyl, haloalkenyl and alkynyl, and
R² is O⁻; forming an N-oxide; and
the 5-membered heterocyle is selected from X2, X4, X6, X8, X12, X18, X33 and X34;
   where
   R⁵, R⁶ and R⁷ are independently selected from hydrogen; halogen; amino; alkyl, alkenyloxy, haloalkenyloxy, alkynyloxy, haloalkynyloxy, alkoxy, and haloalkoxy.

More preferred compositions comprised of N-substituted azacyclic derivatives of the present invention, selected from those set forth above, are those where the azacycle R is selected from W1, W3, W4, W8 and W20; Y and Y¹ are hydrogen; R¹ is selected from methyl and ethyl, and the 5-membered heterocyle is selected i) from X2 where R⁵ is hydrogen and X6 where R⁶ is hydrogen; ii) from X4 and X12, where R⁶ is selected from halogen, alkyl and amino; iii) from X8, where R⁶ is hydrogen and R⁹ is selected from alkyl and arylalkyl; iv) from X18, where R⁸ is alkyl; and v) from X34, where R⁵ is hydrogen and R⁶ is alkoxy.

Yet more preferred compositions comprised of the N-substituted azacyclic derivatives are those compositions where the 5-membered heterocyle is selected i) from X2; ii) from X4, where R¹ is methyl or ethyl; and iii) from X12, where R⁶ is methyl; and even more preferred are those the azacycle R is W3 and the 5-membered heterocyle is selected i) from X4, where R⁶ is methyl; and ii) from X12.

More specifically, compositions comprising a pesticidally effective amount of an N-substituted azacyclic derivative and their agriculturally acceptable salts, in admixture with at least one agriculturally acceptable extender or adjuvant are surprisingly effective as pesticides, i.e., as acaricides and insecticides. The N-substituted azacyclic derivatives may be represented by the following formula I: 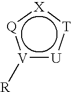
wherein
R is an azacycle selected from the following: 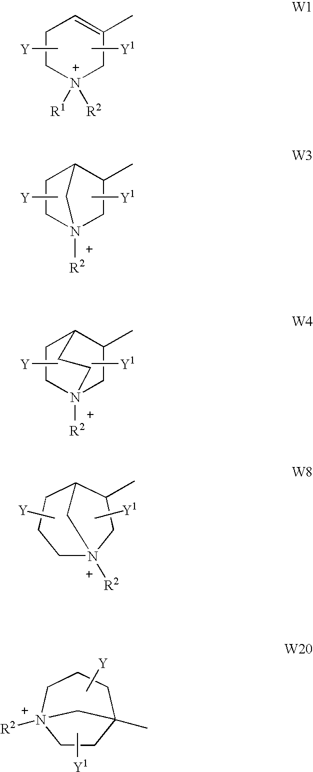
   where
Y and Y¹ may be attached at the same or different positions, and are independently selected from hydrogen and halogen;
R¹ is selected from alkyl, haloalkyl, alkoxyalkyl, arylalkyl, alkenyl, haloalkenyl, alkynyl, haloalkynyl, and
R² is O⁻; forming an N-oxide; and 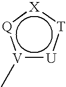
   is a 5-membered heterocycle, wherein V is carbon or nitrogen; Q is carbon or nitrogen; X is carbon, nitrogen or sulfur, T is carbon or nitrogen; and U is carbon, nitrogen, oxygen or sulfur, wherein the 5-membered heterocycle is selected from the following; 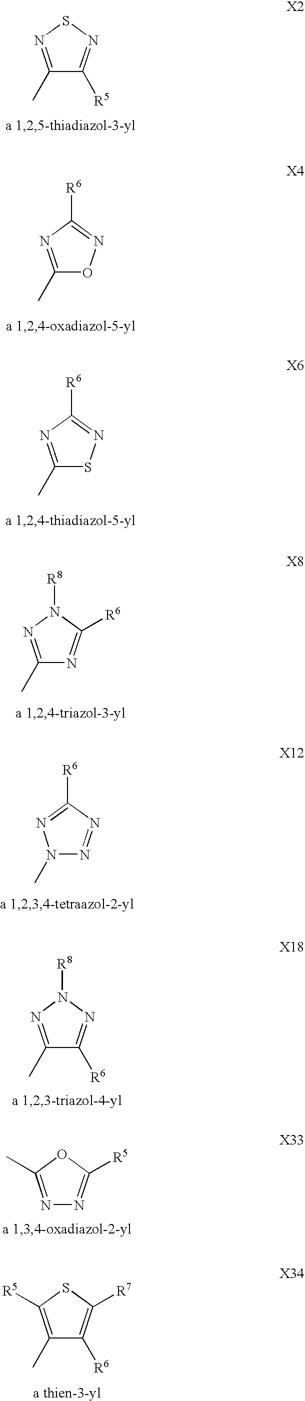
   where
R⁵, R⁶ and R⁷ are independently selected from hydrogen; halogen; amino; alkyl, alkoxy, alkenyloxy, and alkynyloxy; and

the corresponding agriculturally acceptable salts thereof.

Preferred compositions comprised of the N-substituted azacyclic derivatives of the present invention, selected from those set forth above, are those where Y and Y¹ are hydrogen; R¹ is selected from methyl and ethyl and the 5-membered heterocyle is selected i) from X2 where R⁵ is hydrogen and X6 where R⁶ is hydrogen; ii) from X4 and X12, where R⁶ is selected from halogen, alkyl and amino; iii) from X8, where R⁶ is hydrogen and R⁸ is selected from alkyl and arylalkyl; iv) from X18, where R⁸ is alkyl; and v) from X34, where R⁵ is hydrogen and R⁶ is alkoxy.

More preferred compositions comprised of the N-substituted azacyclic derivatives of the present invention, selected from those set forth above, are those where the 5-membered heterocyle is selected i) from X2; ii) from X4, where R⁶ is methyl or ethyl; and iii) from X12, where R⁶ is methyl; and especially preferred are those compositions wherein the azacycle R is W3 and the 5-membered heterocyle is selected i) from X4, where R⁶ is methyl; and ii) from X12.

As used in this specification and unless otherwise indicated, the substituent terms “alkyl” and “alkoxy”, alone or as part of a larger moiety, include chains of 1 to 14 carbon atoms, preferably straight or branched alkyls of 1 to 6 carbon atoms; while “halogen” or “halo”, alone or as part of a larger moiety, includes chlorine, bromine, fluorine, and iodine atoms. The terms “alkenyl” or “alkynyl”, used alone or as part of a larger moiety, includes straight or branched chains of at least two carbon atoms containing at least one carbon-carbon double or triple bond, preferably up to 12 carbon atoms, more preferably, up to ten carbon atoms, most preferably up to seven carbon atoms. The term “cycloalkyl” includes rings of three to twelve carbon atoms, preferably rings of three to six carbon atoms. The terms “haloalkyl” and “haloalkoxy”, alone or as part of a larger moiety, include straight or branched chain alkyls of 1 to 14 carbon atoms, preferably lower straight or branched chain alkyls of 1 to 6 carbon atoms, wherein one or more hydrogen atoms have been replaced with halogen atoms, as, for example, trifluoromethyl or 2,2,2-trifluoroethoxy, respectively. “Aryl” refers to an aromatic ring structure, including fused rings, having 5 to 10 carbon atoms. “Heterocyclyl” refers to an aromatic ring structure, including fused rings, having at least one nitrogen, sulfur or oxygen atom. “Amino” refers to compounds of nitrogen that may be considered derived from ammonia and includes primary, secondary and tertiary amines wherein one or more of the hydrogen atoms is replaced with alkyl groups. “THF” refers to tetrahydrofuran, “DMF” refers to N,N-dimethylformamide, “MeOH” refers to methanol, “EtOH” refers to ethanol, “DMAC” refers to N,N-dimethylacetamide, and “TEA” refers to triethylamine.

The term “pesticide” or “pesticidal” refers to insecticide, acaricide or insecticidal and acaricidal, respectively.

The term “pesticidally effective amount” refers to an insecticidally effective amount and an acaricidally effective amount, and as used in the context of the present invention, refers to a rate of application of a compound of the present invention applied to a locus where insect and acarid control is needed. Such a pesticidally effective amount in the context of the present invention is in the range of 10 ppm to 1000 ppm. Of course, one skilled in the art will realize that the pesticidally effective amount may not be the same to control both insects and acarids.

The term “translaminar” as it relates to the present invention refers to the physical ability of a pesticide to enter a plant such as a crop plant through the outer surface of its leaves or through its root system, thereby becoming a presence within the plants' circulatory system. Pesticides, for example insecticides and acaricides that are translaminar may offer an advantage in that they are longer lasting because they are protected within the plant from such deleterious effects as caused by sunlight and rain washoff. Hence, insecticides and acaricides that are translaminar may provide long term residual insecticidal and acaricidal activity. In addition, translaminar insecticides and acaricides are particularly suited for the control of piercing, sucking pests that feed on saps and juices in the plant.

The compounds of the present invention may be synthesized by methods that are individually known to those skilled in the art from intermediate compounds readily available in commerce. As set forth in the preparative examples below, many of the intermediates penultimate to the N-substituted azacyclic derivatives of the present invention are known compounds synthetically prepared in specific references. For example the intermediate penultimate to Compound 6 (Example 2 below) is compound 11 in J. Med. Chem, 1992, 35, 2274-2283. The intermediate penultimate to Compound 396 (Example 3 below) is compound 7b in J. Med. Chem, 1991, 34, 2726-2735. The intermediate penultimate to Compound 402 (Example 1 below) is compound 2o in J. Med. Chem, 1992, 35, 2392-2406. The intermediate penultimate to Compound 407 (Example 4 below) is compound 28 in J. Med. Chem, 1992, 35, 1280-1290. The intermediate penultimate to Compound 685 (Example 6 below) is compound 9b in J. Med. Chem, 1991, 34, 2726-2735. The penultimate intermediates set forth above were converted to the compounds of formula I of the present invention also by methods known to one skilled in the art. The scheme below sets forth one such method:

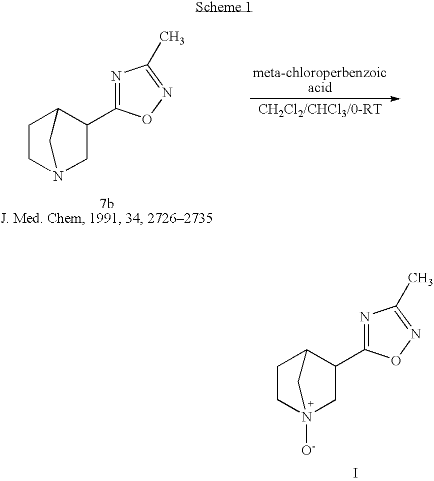

As depicted in Scheme 1 the known compound 7b was oxidized using meta-chloroperbenzoic acid, yielding a compound of formula I.

The compositions of the present invention are those compositions that are normally employed in the art for facilitating the dispersion of active ingredients for the particular utility desired, recognizing the fact that the composition and mode of application of a toxicant may affect the activity of the material in a given application. Thus, for agricultural use the present pesticidal, i.e., insecticidal and acaricidal compositions may be granules of relatively large particle size, water-soluble or water-dispersible granules, powdery dusts, wettable powders, emulsifiable concentrates, solutions, or as any of several other known types of compositions, depending on the desired mode of application.

These insecticidal and acaricidal compositions may be applied either as water-diluted sprays, or dusts, or granules to the areas in which insect and arachnid control is desired. These compositions may contain as little as 0.1%, 0.2% or 0.5% to as much as 95% or more by weight of active ingredient.

Dusts are free flowing admixtures of the active ingredients with finely divided solids such as talc, natural clays, kieselguhr, flours such as walnut shell and cottonseed flours, and other organic and inorganic solids which act as dispersants and carriers for the toxicant; these finely divided solids have an average particle size of less than about 50 microns. A typical dust composition useful herein is one containing 1.0 part or less of the insecticidal and acaricidal compound and 99.0 parts of talc.

Wettable powders are in the form of finely divided particles which disperse readily in water or other dispersant. The wettable powder is ultimately applied to the locus where insect and arachnid control is desired either as a dry dust or as an emulsion in water or other liquid. Typical carriers for wettable powders include Fuller's earth, kaolin clays, silicas, and other highly absorbent, readily wet, inorganic diluents. Wettable powders normally are prepared to contain about 5-80% of active ingredient, depending on the absorbency of the carrier, and usually also contain a small amount of a wetting, dispersing, or emulsifying agent to facilitate dispersion. For example, a useful wettable powder composition contains 80.8 parts of the insecticidal and acaricidal compound, 17.9 parts of Palmetto clay, and 1.0 part of sodium lignosulfonate and 0.3 part of sulfonated aliphatic polyester as wetting agents.

Other useful compositions for insecticidal and acaricidal applications are emulsifiable concentrates (ECs) which are homogeneous liquid compositions dispersible in water or other dispersant, and may consist entirely of the insecticidal and acaricidal compound and a liquid or solid emulsifying agent, or may also contain a liquid carrier, such as xylene, heavy aromatic naphthas, isophorone, or other non-volatile organic solvent. For insecticidal and acaricidal application these concentrates are dispersed in water or other liquid carrier, and normally applied as a spray to the area to be treated. The percentage by weight of the essential active ingredient may vary according to the manner in which the composition is to be applied, but in general comprises 0.5 to 95% of active ingredient by weight of the insecticidal and acaricidal composition.

Flowable compositions are similar to ECs except that the active ingredient is suspended in a liquid carrier, generally water. Flowables, like ECs, may include a small amount of a surfactant, and contain active ingredient in the range of 0.5 to 95%, frequently from 10 to 50%, by weight of the composition. For application, flowables may be diluted in water or other liquid vehicle, and are normally applied as a spray to the area to be treated.

Typical wetting, dispersing, or emulsifying agents used in agricultural compositions include, but are not limited to, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long-chain mercaptans and ethylene oxide. Many other types of useful surface-active agents are available in commerce. The surface-active agents, when used, normally comprise from 1 to 15% by weight of the composition.

Other useful compositions include suspensions of the active ingredient in a relatively non-volatile solvent such as water, corn oil, kerosene, propylene glycol, or other suitable solvents.

Still other useful compositions for insecticidal and acaricidal applications include simple solutions of the active ingredient in a solvent in which it is completely soluble at the desired concentration, such as acetone, alkylated naphthalenes, xylene, or other organic solvents. Granular compositions, wherein the toxicant is carried on relatively coarse particles, are of particular utility for aerial distribution or for penetration of cover crop canopy. Pressurized sprays, typically aerosols wherein the active ingredient is dispersed in finely divided form as a result of vaporization of a low boiling dispersant solvent carrier, such as carbon dioxide, propane, or butane, may also be used. Water-soluble or water-dispersible granules are also useful compositions for insecticidal and acaricidal application of the present compounds. Such granular compositions are free-flowing, non-dusty, and readily water-soluble or water-miscible. The soluble or dispersible granular compositions described in U.S. Pat. No. 3,920,442 are useful herein with the present insecticidal and acaricidal compounds. In use by the farmer on the field, the granular compositions, emulsifiable concentrates, flowable concentrates, solutions, etc., may be diluted with water to give a concentration of active ingredient in the range of say 0.1% or 0.2% to 1.5% or 2%.

The active insecticidal compounds of this invention may be formulated and/or applied with one or more second compounds. Second compounds include, but are not limited to, other pesticides, plant growth regulators, fertilizers, soil conditioners, or other agricultural chemicals. In applying an active compound of this invention, whether formulated alone or with other agricultural chemicals, an effective amount and concentration of the active compound is of course employed; the amount may vary in the range of, e.g. about 0.02 to about 1.5 kg/ha, preferably about 0.05 to about 0.3 kg/ha. For field use, where there are losses of insecticide, higher application rates (e.g., four times the rates mentioned above) may be employed.

When the active pesticidal compounds of the present invention are used in combination with one or more of second compounds, e.g., with other pesticides such as herbicides, the herbicides include, without limitation, for example: N-(phosphonomethyl)glycine (“glyphosate”); aryloxyalkanoic acids such as (2,4-dichlorophenoxy)acetic acid (“2,4-D”), (4-chloro-2-methylphenoxy)acetic acid (“MCPA”), (+/−)-2-(4chloro-2-methylphenoxy)propanoic acid (“MCPP”); ureas such as N,N-dimethyl-N′-[4-(1-methylethyl)phenyl]urea (“isoproturon”); imidazolinones such as 2-[4,5-dihydro-4-methyl-4-(1-methylethyl)-5-oxo-1H-imidazol-2-yl]-3-pyridinecarboxylic acid (“imazapyr”), a reaction product comprising (+/−)-2-[4,5-dihydro-4-methyl-4-(1-methylethyl)-5-oxo-1H-imidazol-2-yl]-4-methylbenzoic acid and (+/−)2-[4,5-dihydro-4-methyl-4-(1-methylethyl)-5-oxo-1H-imidazol-2-yl]-5-methylbenzoic acid (“imazamethabenz”), (+/−)-2-[4,5-dihydro-4-methyl-4-(1-methylethyl)-5-oxo-1H-imidazol-2-yl]-5-ethyl-3-pyridinecarboxylic acid (“imazethapyr”), and (+/−)-2-[4,5-dihydro-4-methyl-4-(1-methylethyl)-5-oxo-1H-imidazol-2-yl]-3-quinolinecarboxylic acid (“imazaquin”); diphenyl ethers such as 5-[2-chloro-4-(trifluoromethyl)phenoxy]-2-nitrobenzoic acid (“acifluorfen”), methyl 5-(2,4-dichlorophenoxy)-2-nitrobenzoate (“bifenox”), and 5-[2-chloro-4-(trifluoromethyl)phenoxy]-N-(methylsulfonyl)-2-nitrobenzamide (“fomasafen”); hydroxybenzonitriles such as 4-hydroxy-3,5-diiodobenzonitrile (“ioxynil”) and 3,5-dibromo-4-hydroxybenzonitrile (“bromoxynil”); sulfonylureas such as 2-[[[[(4chloro-6-methoxy-2-pyrimidinyl)amino]carbonyl]amino]sulfonyl]benzoic acid (“chlorimuron”), 2-chloro-N-[[(4-methoxy-6-methyl-1,3,5-triazin-2-yl)amino]carbonyl]benzenesulfonamide (achlorsulfuron”), 2-[[[[[(4,6-dimethoxy-2-pyrimidinyl)amino]carbonyl]amino]sufonyl]methyl]benzoic acid (“bensulfuron”), 2-[[[[(4,6-dimethoxy-2-pyrimidinyl)amino]carbonyl]amino]sulfonyl]-1-methy-1H-pyrazol-4-carboxylic acid (“pyrazosulfuron”), 3-[[[[(4-methoxy-6-methyl-1,3,5-triazin-2-yl)amino]carbonyl]amino]sulfonyl]-2-thiophenecarboxylic acid (“thifensulfuron”), and 2-(2-chloroethoxy)-N[[(4-methoxy-6-methyl-1,3,5-triazin-2-yl)amino]carbonyl]benzenesulfonamide (“triasulfuron”); 2-(4-aryloxy-phenoxy)alkanoic acids such as (+/−)-2[4-[(6-chloro-2-benzoxazolyl)oxy]phenoxy]-propanoic acid (fenoxaprop”), (+/−)-2-[4[[5-(trifluoromethyl)-2-pyridinyl]oxy]-phenoxy]propanoic acid (“fluazifop”), (+/−)-2-[4-(6chloro-2-quinoxalinyl)oxy]-phenoxy]propanoic acid (“quizalofop”), and (+/−)-2-[(2,4-dichlorophenoxy)phenoxy]propanoic acid (“diclofop”); benzothiadiazinones such as 3-(1-methylethyl)-1H-1,2,3-benzothiadiazin-4(3H)-one-2,2-dioxide (“bentazone”); 2-chloroacetanilides such as N-(butoxymethyl)-2-chloro-N-(2,6-diethylphenyl)acetamide (“butachlor”), 2-chloro-N-(2-ethyl-6-methylphenyl)-N-(2-methoxy-1-methylethyl)acetamide (“metolachlor”), 2-chloro-N-(ethoxymethyl)-N-(2-ethyl-6-methylphenyl)acetamide (“acetochlor”), and (RS)-2-chloro-N-(2,4-dimethyl-3-thienyl)-N-(2-methoxy-1-methylethyl)acetamide (“dimethenamide”); arenecarboxylic acids such as 3,6-dichloro-2-methoxybenzoic acid (“dicamba”); pyridyloxyacetic acids such as [(4-amino-3,5-dichloro-6-fluoro-2-pyridinyl)oxy]acetic acid (“fluroxypyr”), and other herbicides.

When the active pesticidal compounds of the present invention are used in combination with one or more of second compounds, e.g., with other pesticides such as other insecticides, the other insecticides include, for example: organophosphate insecticides, such as chlorpyrifos, diazinon, dimethoate, malathion, parathion-methyl, and terbufos; pyrethroid and non-pyrethroid insecticides, such as fenvalerate, deltamethrin, fenpropathrin, cyfluthrin, flucythrinate, alpha-cypermethrin, bifenthrin, cypermethrin, resolved cyhalothrin, etofenprox, esfenvalerate, tralomethrin, tefluthrin, cycloprothrin, betacyfluthrin, acrinathrin and silafluofen; carbamate insecticides, such as aldicarb, carbaryl, carbofuran, and methomyl; organochlorine insecticides, such as endosulfan, endrin, heptachlor, and lindane; benzoylurea insecticides, such as diflubenuron, triflumuron, teflubenzuron, chlorfluazuron, flucycloxuron, hexaflumuron, noviflumuron, flufenoxuron, and lufenuron; and other insecticides, such as, without limitation, amitraz, clofentezine, fenpyroximate, hexythiazox, cyhexatin, spinosad, imidacloprid, chlorfenaptr, hydramethylon, acequinocyl, fenbutatin-oxide, methoxyfenozide, tebufenozide, halofenozide, indoxacarb, fipronyl, ethiprole, etoxazole, bifenazate, spirodiclofen, spiromesifen, methoprene, pyriproxyfen, fenoxycarb, pymetrozine, abamectin, emamectin benzoate, milbemectin, and other insecticides.

When the active pesticidal compounds of the present invention are used in combination with one or more of second compounds, e.g., with other pesticides such as fungicides, the fungicides include, for example: benzimidazole fungicides, such as benomyl, carbendazim, thiabendazole, and thiophanate-methyl; 1,2,4-triazole fungicides, such as epoxyconazole, cyproconazole, flusilazole, flutriafol, propiconazole, tebuconazole, triadimefon, and triadimenol; substituted anilide fungicides, such as metalaxyl, oxadixyl, procymidone, and vinclozolin; organophosphorus fungicides, such as fosetyl, iprobenfos, pyrazophos, edifenphos, and tolclofos-methyl; morpholine fungicides, such as fenpropimorph, tridemorph, and dodemorph; other systemic fungicides, such as fenarimol, imazalil, prochloraz, tricyclazole, and triforine; dithiocarbamate fungicides, such as mancozeb, maneb, propineb, zineb, and ziram; non-systemic fungicides, such as chlorothalonil, dichlofluanid, dithianon, and iprodione, captan, dinocap, dodine, fluazinam, gluazatine, PCNB, pencycuron, quintozene, tricylamide, and validamycin; inorganic fungicides, such as copper and sulphur products, and other fungicides.

When the active pesticidal compounds of the present invention are used in combination with one or more of second compounds, e.g., with other pesticides such as nematicides, the nematicides include, for example: carbofuran, carbosulfan, turbufos, aldecarb, ethoprop, fenamphos, oxamyl, isazofos, cadusafos, and other nematicides.

When the active pesticidal compounds of the present invention are used in combination with one or more of second compounds, e.g., with other materials such as plant growth regulators, the plant growth regulators include, for example: maleic hydrazide, chlormequat, ethephon, gibberellin, mepiquat, thidiazon, inabenfide, triaphenthenol, paclobutrazol, unaconazol, DCPA, prohexadione, trinexapac-ethyl, and other plant growth regulators.

Soil conditioners are materials which, when added to the soil, promote a variety of benefits for the efficacious growth of plants. Soil conditioners are used to reduce soil compaction, promote and increase effectiveness of drainage, improve soil permeability, promote optimum plant nutrient content in the soil, and promote better pesticide and fertilizer incorporation. When the active pesticidal compounds of the present invention are used in combination with one or more of second compounds, e.g., with other materials such as soil conditioners, the soil conditioners include organic matter, such as humus, which promotes retention of cation plant nutrients in the soil; mixtures of cation nutrients, such as calcium, magnesium, potash, sodium, and hydrogen complexes; or microorganism compositions which promote conditions in the soil favorable to plant growth. Such microorganism compositions include, for example, bacillus, pseudomonas, azotobacter, azospirillum, rhizobium, and soil-borne cyanobacteria.

Fertilizers are plant food supplements, which commonly contain nitrogen, phosphorus, and potassium. When the active pesticidal compounds of the present invention are used in combination with one or more of second compounds, e.g., with other materials such as fertilizers, the fertilizers include nitrogen fertilizers, such as ammonium sulfate, ammonium nitrate, and bone meal; phosphate fertilizers, such as superphosphate, triple superphosphate, ammonium sulfate, and diammonium sulfate; and potassium fertilizers, such as muriate of potash, potassium sulfate, and potassium nitrate, and other fertilizers.

In some cases, the effectiveness of such combinations may be improvement. For example, such combinations may exhibit synergistic effects, reduced rates of application resulting in improved user safety, control a broader spectrum of pests, improved tolerance by plants, and improved tolerance by non-pest species, such as mammals and fish.

The methods of the present invention are predicated on causing an insecticidal or acaricidal amount of a compound of Formula I to be present within insects or acarids and, thereby, killing or controlling the insects or acarids. It is possible and is within the scope of the invention to cause a compound of Formula I wherein R⁵, R⁶ and R⁷ represent amino (NH₂) to be present within insects or acarids by contacting the insects or acarids with a derivative of that compound, which derivative is converted within the insects or acarids to a compound of Formula I wherein R⁵, R⁶ and R⁷ represent amino. Such compounds, which can be referred to as pro-insecticides, include compounds containing an R⁵, R⁶ and R⁷ substituent that can be converted to NH₂ by chemical processes, such as hydrolysis, oxidation, reduction, and the like, that are either enzymatic or non-enzymatic in nature. Suitable substituents include N-acylamino, N-substituted imino, and N-sulfenyl amino groups, and the like. Some examples, wherein hydrocarbyl refers to an aliphatic or aromatic hydrocarbon moiety optionally substituted with halogen, hydroxy, alkoxy, cyano, or nitro, or the like, are illustrated below:

NH—CO(hydrocarbyl); NH—CH(OH)(hydrocarbyl); NH—CO₂(hydrocarbyl); N═CH(hydrocarbyl); NH—CO—NH(hydrocarbyl); NH—S(hydrocarbyl); NH—COCO₂(hydrocarbyl); NH—S—N(hydrocarbyl)₂; NH—C(S-(hydrocarbyl))=N(hydrocarbyl); NH—CH(O-(hydrocarbyl))(hydrocarbyl)

Compounds containing such substituents can be prepared from compounds of Formula I wherein R⁵, R⁶ and R⁷ represent NH₂ by well established methods known to those in the art. For example, N-acyl derivatives can be prepared by treatment with an acyl halide or anhydride, N-substituted imino derivatives can be prepared by treatment with aldehydes, urea derivatives can be prepared by treatment with isocyanates, N-sulfenyl derivatives can be prepared by treatment with a sulfenyl chloride, carbamate derivatives can be prepared by treatment with a chloroformate ester, and isothiourea derivatives can be prepared by treatment with first an isothiocyanate and then a hydrocarbyl halide.

It is further possible and within the scope of the invention to cause a compound of Formula I wherein R⁵, R⁶ and R⁷ represent hydroxy (OH) to be present within insects or acarids by contacting the insects or acarids with a derivative of that compound, which derivative is converted within the insects or acarids to a compound of Formula I wherein R⁵, R⁶ and R⁷ represent hydroxy. Such compounds are also pro-insecticides. Suitable compounds include compounds containing an R⁵, R⁶ and R⁷ substituent that can be converted to OH by chemical processes, such as hydrolysis, oxidation, reduction, and the like, that are either enzymatic or non-enzymatic in nature. Typical substituents include acyloxy, carbamoyloxy, and carbonyl. Some examples, wherein hydrocarbyl refers to an aliphatic or aromatic hydrocarbon moiety optionally substituted with halogen, hydroxy, alkoxy, cyano, or nitro, or the like are illustrated below:

O—CO(hydrocarbyl; O—CH₃; O—CO₂(hydrocarbyl); O—C(CH₃)₂—O-hyrdocarboyl; O—C(O)—N(hydrocarbyl)₂; O—CH₂OCH₃; O—C(O)—NH₂; O—CH₂CH═CH₂; O—SO₃⁻M⁺; O—PO₃⁻M⁺

Compounds of these types can be prepared from compounds of Formula I wherein R⁵, R⁶ and R⁷ represent OH by methods well established in the art. For example, acyloxy derivatives may be prepared by treatment with acid halides or anhydrides; carbamoyloxy derivatives can be prepared by treatment with a carbamoyl chloride; and carbonyl derivatives can be prepared by treatment with a carbonate or chloroformate.

It is further possible and within the scope of the invention to cause a compound of Formula I wherein R⁵, R⁶ and R⁷ represent mercapto or thiol (SH) to be present within insects or acarids by contacting the insects or acarids with a derivative of that compound, which derivative is converted within the insects or acarids to a compound of Formula I wherein R⁵, R⁶ and R⁷ represent mercapto. Such compounds are also pro-insecticides. Suitable compounds include compounds containing an R⁵, R⁶ and R⁷ substituent that can be converted to SH by chemical processes, such as hydrolysis, oxidation, reduction, and the like, that are either enzymatic or non-enzymatic in nature. Typical substituents include acylthio and hydrocarbyloxyalkylthio, wherein hydrocarbyl refers to an aliphatic or aromatic hydrocarbon moiety optionally substituted with halogen, hydroxy, alkoxy, cyano, or nitro, or the like. Some examples are illustrated below:
S—C(O)-hydrocarbyl; S—CH₂O₂C(hydrocarbyl); S—CH₃; S—C(O)-aryl

Compounds of these types can be prepared from a compound of Formula I wherein R⁵, R⁶ and R⁷ represent SH by methods well established in the art. For example, acylthio derivatives may be prepared by treatment with acyl halides or anhydrides and hydrocarbyloxyalkylthio derivatives may be prepared by treatment with a hydrocarbylheteroalkyl halide.

The present invention also includes the use of the compounds and compositions set forth herein for control of non-agricultural insect species, for example, dry wood termites and subterranean termites; as well as for use as pharmaceutical agents. In the field of veterinary medicine, the compounds of the present invention are expected to be effective against certain endo- and ecto-parasites, such as insects and worms, which prey on animals. Examples of such animal parasites include, without limitation, Gastrophilus spp., Stomoxys spp., Trichodectes spp., Rhodnius spp., Ctenocephalides canis, and other species.

The following examples further illustrate the present invention, but, of course, should not be construed as in any way limiting its scope. The examples are organized to present protocols for the synthesis of the compounds of formula I of the present invention, set forth a list of such synthesized species, and set forth certain biological data indicating the efficacy of such compounds.

### EXAMPLE 1

This Example Illustrates One Protocol for the Preparation of the N-Oxide of 2-(4-azabicyclo[2.2.1]heptyl-2-yl)-5-methyl-1,2,3,4-tetrazole (Compound 402).

The intermediate 2-(4-azabicyclo[2.2.1]heptyl-2-yl)-5-methyl-1,2,3,4-tetrazole (prepared by Jenkins et al as Compound 2o in J. Med. Chem, 1992, 35, 2392-2406), 0.03 gram (0.00017 mole), was taken up in 1 mL of chloroform. Upon dissolution, the solution was cooled to 0° C. and 0.041 gram (0.00018 mole) of meta-chloroperbenzoic acid was added in three portions. Upon completion of addition, the reaction mixture was allowed to warm to ambient temperature where it stirred for about 20 minutes. Upon completion of this period, the reaction mixture was analyzed by TLC, which indicated that the reaction was complete. The reaction mixture was subjected to small column chromatography on neutral alumina. The product-containing fractions were combined and concentrated under reduced pressure, yielding 0.029 gram of Compound 402. The NMR spectrum was consistent with the proposed structure.

### EXAMPLE 2

This Example Illustrates One Protocol for the Preparation of the N-Oxide of 3-[1-methyl(1,2,5,6-tetrahydropyrid-3-yl)]-1,2,5-thiadiazole (Compound 6).

The intermediate 3-[1-methyl(1,2,5,6-tetrahydropyrid-3-yl)]-1,2,5-thiadiazole (prepared by Sauerburg as compound 11 in J. Med. Chem, 1992, 35, 2274-2283) was converted to the N-oxide (compound 6) in by the method set forth in Example 1; using 0.05 gram (0.000265 mole) of the intermediate 1,2,5-thiadiazole, and 0.07 gram (0.000270 mole) of meta-chloroperbenzoic acid in 10 mL of methylene chloride. The reaction mixture was subjected to small column chromatography on silica gel. The product-containing fractions were combined and concentrated under reduced pressure, yielding 0.045 gram of Compound 6. The NMR spectrum was consistent with the proposed structure.

### EXAMPLE 3

This Example Illustrates One Protocol for the Preparation of the N-Oxide of 5-(4-azabicyclo[2.2.1]hept-2-yl)-3-methyl-1,2,4-oxadiazole (Compound 396).

The intermediate 5-(4-azabicyclo[2.2.1]hept-2-yl)-3-methyl-1,2,4-oxadiazole (prepared by Orlek as compound 7b in J. Med. Chem, 1991, 34, 2726-2735) was converted to the N-oxide (compound 396) by the method set forth in Example 1; using 0.28 gram (0.000156 mole) of the intermediate 1,2,4-oxadiazole, and 0.035 gram (0.000156 mole) of meta-chloroperbenzoic acid in 6 mL of a mixture of methylene chloride and chloroform. The reaction mixture was subjected to small column chromatography on silica gel. The product-containing fractions were combined and concentrated under reduced pressure, yielding 0.030 gram of Compound 396. The NMR spectrum was consistent with the proposed structure.

### EXAMPLE 4

This Example Illustrates One Protocol for the Preparation of the N-Oxide of 5-methyl-2-quinuclidin-3-yl-1,2,3,4-tetraazole (Compound 407).

The intermediate 5-methyl-2-quinuclidin-3-yl-1,2,3,4-tetraazole (prepared by Wadsworth et al as compound 28 in J. Med. Chem, 1992, 35, 1280-1290) was converted to the N-oxide (compound 407) by the method set forth in Example 1; using 0.060 gram (0.00031 mole) of the intermediate 1,2,3,4-tetraazole and 0.077 gram (0.00034 mole) of meta-chloroperbenzoic acid in 1.5 mL of chloroform. The reaction mixture was subjected to small column chromatography on neutral alumina activity III (6% water). The product-containing fractions were combined and concentrated under reduced pressure, yielding 0.055 gram of Compound 407. The NMR spectrum was consistent with the proposed structure.

### EXAMPLE 5

This Example Illustrates One Protocol for the Preparation of the N-Oxide of 5-(4-azabicyclo[2.2.1]hept-2-yl)-3-ethyl-1,2,4-oxadiazole (Compound 397)

The intermediate 5-(4-azabicyclo[2.2.1]hept-2-yl)-3-ethyl-1,2,4-oxadiazole (prepared by Orlek as the ethyl derivative of compound 7b in J. Med. Chem, 1991, 34, 2726-2735) was converted to the N-oxide (compound 397) by the method set forth in Example 1; using 0.05 gram (0.00026 mole) of the intermediate 1,2,4-oxadiazole, and 0.064 gram (0.00029 mole) of meta-chloroperbenzoic acid in 2 mL of chloroform. The reaction mixture was subjected to small column chromatography on silica gel. The product-containing fractions were combined and concentrated under reduced pressure, yielding 0.025 gram of Compound 397. The NMR spectrum was consistent with the proposed structure.

### EXAMPLE 6

This Example Illustrates One Protocol for the Preparation of the N-Oxide of 2-(5-azabicyclo[3.2.1]octyl)-5-methyl-1,3,4-oxadiazole (Compound 685).

The intermediate 2-(5-azabicyclo[3.2.1]octyl)-5-methyl-1,3,4-oxadiazole (prepared by Orlek as compound 9b in J. Med. Chem, 1991, 34, 2726-2735) was converted to the N-oxide (compound 685) by thr method set forth in Example 1; using 0.060 gram (0.00031 mole) of the intermediate 1,3,4-oxadiazole and 0.084 gram (0.00037 mole) of meta-chloroperbenzoic acid in about 2 mL of chloroform. The reaction mixture was subjected to small column chromatography on neutral alumina. The product-containing fractions were combined and concentrated under reduced pressure, yielding about 0.040 gram of Compound 685. The NMR spectrum was consistent with the proposed structure.

The following table sets forth some compounds of formula I:

TABLE 1
Pesticidal N-Substituted Azacyclic Derivatives

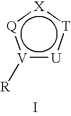

where R is an azacycle selected from:

| | |
|---|---|
| 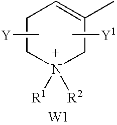 | 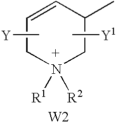 |
| 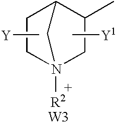 | 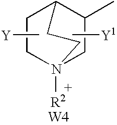 |
| 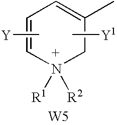 | 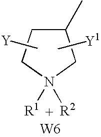 |
| 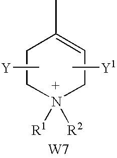 | 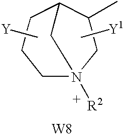 |
| 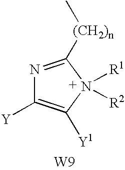 | 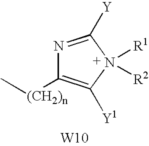 |
| 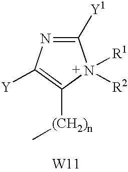 | 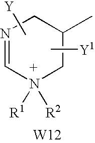 |
| 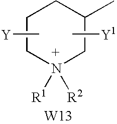 | 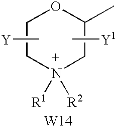 |
| 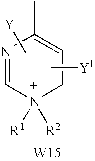 | 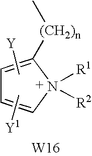 |
| 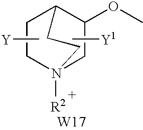 | 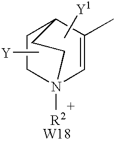 |
| 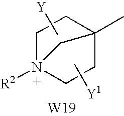 | 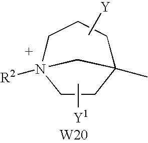 |
| 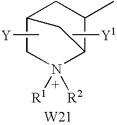 | 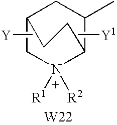 |
| 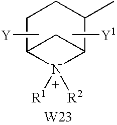 | 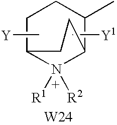 |
| 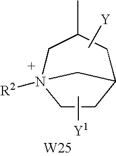 | 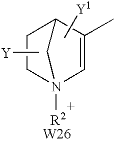 |
| 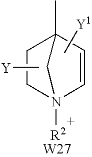 | 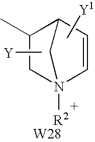 |
| 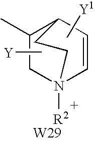 | 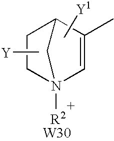 |
| 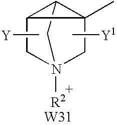 | 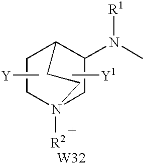 |
| 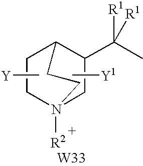 | 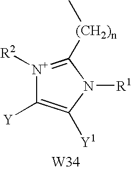 |
| 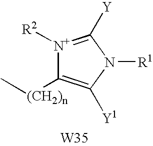 | 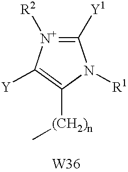 |
| 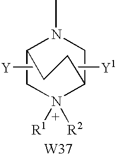 | 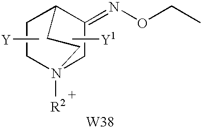 |
| 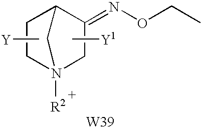 | 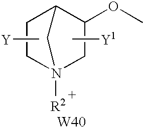 |

and

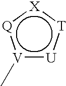

is a five-membered heterocycle selected from:

| | | |
|---|---|---|
| 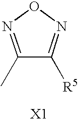 | 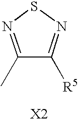 | 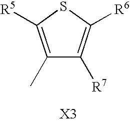 |
| a 1,2,5-oxadiazol-3-yl | a 1,2,5-thiadiazol-3-yl | a thien-3-yl |
| 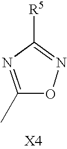 | 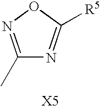 | 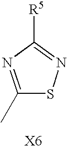 |
| a 1,2,4-oxadiazol-5-yl | a 1,2,4-oxadiazol-3-yl | a 1,2,4-thiadiazol-5-yl |
| 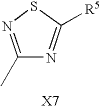 | 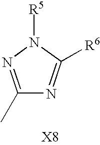 | 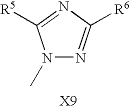 |
| a 1,2,4-thiadiazol-3-yl | a 1,2,4-triazol-3-yl | a 1,2,4-triazol-1-yl |
| 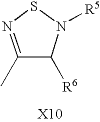 | 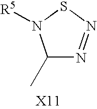 | 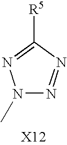 |
| a 1,2,5-thiadiazolin-3-yl | a 1,2,3,5-thiatriazolin-4-yl | a 1,2,3,4-tetraazol-2-yl |
| 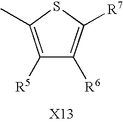 | 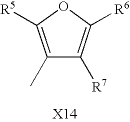 | 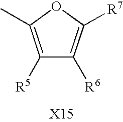 |
| a thien-2-yl | a furan-3-yl | a furan-2-yl |
| 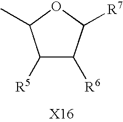 | 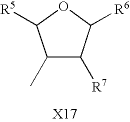 | 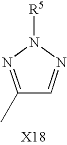 |
| a tetrahydrofuran-2-yl | a tetrahydrofuran-2-yl | a 1,2,3-triazol-4-yl |
| 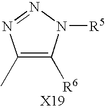 | 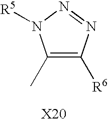 | 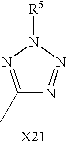 |
| a 1,2,3-triazol-4-yl | a 1,2,3-triazol-4-yl | a tetraazol-5-yl |
| 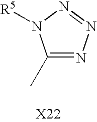 | 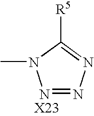 | 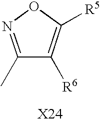 |
| a tetraazol-5-yl | a 1,2,3,4-tetraazol-1-yl | an isoxazol-3-yl |
| 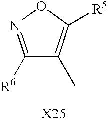 | 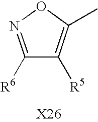 | 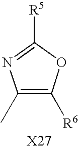 |
| an isoxazol-4-yl | an isoxazol-5-yl | a 1,3-oxazol-4-yl |
| 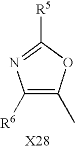 | 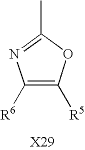 | 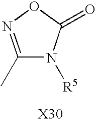 |
| an oxazol-5-yl | an oxazol-2-yl | a 2-oxadiazolidinon-4-yl |
| 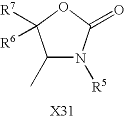 | 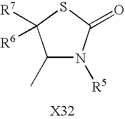 | 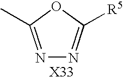 |
| a 2-oxazolidinon-4-yl | a 2-thazolidinon-4-yl | a 1,3,4-oxadiazol-2-yl |
| 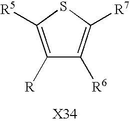 | 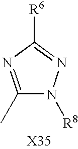 | |
| a thien-3-yl | a 1H-1,2,4-triazol-5-yl | |

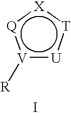

where the five-membered heterocycle is X2, a 1,2,5-thiadiazol-3-yl

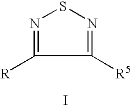

| Cmpd. | | | | | | | |
|---|---|---|---|---|---|---|---|
| No. | R | R5 | Y | n | | | |
| 1 | W1 | H | —CH₂Ph | O^{—} | H | H | — |
| 2 | W1 | Cl | H | O^{—} | H | H | — |
| 3 | W1 | Cl | —CH₂Ph | O^{—} | H | H | — |
| 4 | W1 | F | —CH₂Ph | O^{—} | H | H | — |
| 5 | W1 | Cl | —CO₂C₂H₅ | O^{—} | H | H | — |
| 6 | W1 | H | —CH₃ | O^{—} | H | H | — |
| 7 | W1 | H | —CH₃ | O^{—} | 2-Cl | H | — |
| 8 | W1 | H | —CH₃ | O^{—} | 2-CH₃ | H | — |
| 9 | W1 | H | —CH₃ | O^{—} | 4-Cl | H | — |
| 10 | W1 | H | —CH₃ | O^{—} | 4-CH₃ | H | — |
| 11 | W1 | H | —CH₃ | O^{—} | 6-Cl | H | — |
| 12 | W1 | H | —CH₃ | O^{—} | 6-CH₃ | H | — |
| 13 | W1 | H | —CH₃ | O^{—} | 2-F | 2-F | — |
| 14 | W1 | H | —CH₃ | O^{—} | 2-CH₃ | 2-CH₃ | — |
| 15 | W1 | H | —CH₃ | O^{—} | 6-F | 6-F | — |
| 16 | W1 | H | —CH₃ | O^{—} | 6-CH₃ | 6-CH₃ | — |
| 17 | W1 | H | —C₂H₅ | O^{—} | H | H | — |
| 18 | W1 | H | —CH₂OCH₃ | O^{—} | H | H | — |
| 19 | W1 | Cl | —CH₃ | O^{—} | H | H | — |
| 20 | W1 | F | —CH₃ | O^{—} | H | H | — |
| 21 | W1 | F | —CH₃ | O^{—} | 2-Cl | H | — |
| 22 | W1 | F | —CH₃ | O^{—} | 2-F | H | — |
| 23 | W1 | F | —CH₃ | O^{—} | 2-CH₃ | H | — |
| 24 | W1 | F | —CH₃ | O^{—} | 4-Cl | H | — |
| 25 | W1 | F | —CH₃ | O^{—} | 4-F | H | — |
| 26 | W1 | F | —CH₃ | O^{—} | 4-CH₃ | H | — |
| 27 | W1 | F | —CH₃ | O^{—} | 6-Cl | H | — |
| 28 | W1 | F | —CH₃ | O^{—} | 6-F | H | — |
| 29 | W1 | F | —CH₃ | O^{—} | 6-CH₃ | H | — |
| 30 | W1 | F | —CH₃ | O^{—} | 2-Cl | 2-Cl | — |
| 31 | W1 | F | —CH₃ | O^{—} | 2-F | 2-F | — |
| 32 | W1 | F | —CH₃ | O^{—} | 2-CH₃ | 2-CH₃ | — |
| 33 | W1 | F | —CH₃ | O^{—} | 6-Cl | 6-Cl | — |
| 34 | W1 | F | —CH₃ | O^{—} | 6-F | 6-F | — |
| 35 | W1 | F | —CH₃ | O^{—} | 6-CH₃ | 6-CH₃ | — |
| 36 | W1 | —CH₃ | —CH₃ | O^{—} | H | H | — |
| 37 | W1 | —CH₃ | —CH₃ | O^{—} | 2-Cl | H | — |
| 38 | W1 | —CH₃ | —CH₃ | O^{—} | 2-F | H | — |
| 39 | W1 | —CH₃ | —CH₃ | O^{—} | 2-CH₃ | H | — |
| 40 | W1 | —CH₃ | —CH₃ | O^{—} | 4-Cl | H | — |
| 41 | W1 | —CH₃ | —CH₃ | O^{—} | 4-F | H | — |
| 42 | W1 | —CH₃ | —CH₃ | O^{—} | 4-CH₃ | H | — |
| 43 | W1 | —CH₃ | —CH₃ | O^{—} | 6-Cl | H | — |
| 44 | W1 | —CH₃ | —CH₃ | O^{—} | 6-F | H | — |
| 45 | W1 | —CH₃ | —CH₃ | O^{—} | 6-CH₃ | H | — |
| 46 | W1 | —CH₃ | —CH₃ | O^{—} | 2-Cl | 2-Cl | — |
| 47 | W1 | —CH₃ | —CH₃ | O^{—} | 2-F | 2-F | — |
| 48 | W1 | —CH₃ | —CH₃ | O^{—} | 2-CH₃ | 2-CH₃ | — |
| 49 | W1 | —CH₃ | —CH₃ | O^{—} | 6-Cl | 6-Cl | — |
| 50 | W1 | —CH₃ | —CH₃ | O^{—} | 6-F | 6-F | — |
| 51 | W1 | —CH₃ | —CH₃ | O^{—} | 6-CH₃ | 6-CH₃ | — |
| 52 | W1 | —CH₂CH₂C₆H₅ | —CH₃ | O^{—} | H | H | — |
| 53 | W1 | —OCH₃ | —CH₃ | O^{—} | H | H | — |
| 54 | W1 | —OC₂H₅ | —CH₃ | O^{—} | H | H | — |
| 55 | W1 | —OC₃H₇ | —CH₃ | O^{—} | H | H | — |
| 56 | W1 | 4-FPhO— | —CH₃ | O^{—} | H | H | — |
| 57 | W1 | —OCH₂CH═CH₂ | —CH₃ | O^{—} | H | H | — |
| 58 | W1 | —OCH₂C≡CH | —CH₃ | O^{—} | H | H | — |
| 59 | W1 | —OCH₂C≡CCH₃ | —CH₃ | O^{—} | H | H | — |
| 60 | W1 | —SCH₃ | —CH₃ | O^{—} | H | H | — |
| 61 | W1 | —SC₂H₅ | —CH₃ | O^{—} | H | H | — |
| 62 | W1 | —SC₃H₇ | —CH₃ | O^{—} | H | H | — |
| 63 | W1 | —SC₄H₉ | —CH₃ | O^{—} | H | H | — |
| 64 | W1 | —SC₅H₁₁ | —CH₃ | O^{—} | H | H | — |
| 65 | W1 | —SC₅H₁₀CN | —CH₃ | O^{—} | H | H | — |
| 66 | W1 | —SCH₂CH═CH₂ | —CH₃ | O^{—} | H | H | — |
| 67 | W1 | —SCH₂C≡CH | —CH₃ | O^{—} | H | H | — |
| 68 | W2 | —CO₂C₄H₉ | —CH₃ | O^{—} | H | H | — |
| 69 | W3 | H | — | O^{—} | H | H | — |
| 70 | W3 | H | — | O^{—} | 2-F | H | — |
| 71 | W3 | H | — | O^{—} | 2-CH₃ | H | — |
| 71 | W3 | H | — | O^{—} | 4-Cl | H | — |
| 72 | W3 | H | — | O^{—} | 4-CH₃ | H | — |
| 73 | W3 | H | — | O^{—} | 6-Cl | H | — |
| 74 | W3 | H | — | O^{—} | 6-F | H | — |
| 75 | W3 | H | — | O^{—} | 6-CH₃ | H | — |
| 76 | W3 | H | — | O^{—} | 2-Cl | 2-Cl | — |
| 77 | W3 | H | — | O^{—} | 2-CH₃ | 2-CH₃ | — |
| 78 | W3 | H | — | O^{—} | 6-Cl | 6-Cl | — |
| 79 | W3 | H | — | O^{—} | 6-F | 6-F | — |
| 80 | W3 | Cl | — | O^{—} | H | H | — |
| 81 | W3 | F | — | O^{—} | H | H | — |
| 82 | W3 | CH₃ | — | O^{—} | H | H | — |
| 83 | W3 | —OCH₂C≡CH | — | O^{—} | H | H | — |
| 84 | W4 | H | — | O^{—} | H | H | — |
| 85 | W4 | F | — | O^{—} | H | H | — |
| 86 | W4 | Cl | — | O^{—} | H | H | — |
| 87 | W4 | Cl | — | O^{—} | 3-Cl | H | — |
| 88 | W4 | Cl | — | O^{—} | 2-Cl | 2-Cl | — |
| 89 | W4 | Cl | — | O^{—} | 6-CH₃ | 6-CH₃ | — |
| 90 | W4 | —OCH₃ | — | O^{—} | H | H | — |
| 91 | W4 | —OC₂H₅ | — | O^{—} | H | H | — |
| 92 | W4 | —OC₃H₇ | — | O^{—} | H | H | — |
| 93 | W4 | —OC₄H₉ | — | O^{—} | H | H | — |
| 94 | W4 | —OCH₂CH═CH₂ | — | O^{—} | H | H | — |
| 95 | W4 | —OCH₂C≡CH | — | O^{—} | H | H | — |
| 96 | W4 | —OCH₂C≡CCH₃ | — | O^{—} | H | H | — |
| 97 | W4 | —OCH₂CH₂C≡CH | — | O^{—} | H | H | — |
| 98 | W4 | —SCH₃ | — | O^{—} | H | H | — |
| 99 | W4 | —SC₂H₅ | — | O^{—} | H | H | — |
| 100 | W4 | —SC₃H₇ | — | O^{—} | H | H | — |
| 101 | W4 | —SC₄H₉ | — | O^{—} | H | H | — |
| 102 | W4 | —SC₆H₁₃ | — | O^{—} | H | H | — |
| 103 | W4 | —SC₆H₁₂CN | — | O^{—} | H | H | — |
| 104 | W4 | —SCH₂CH═CH₂ | — | O^{—} | H | H | — |
| 105 | W4 | —SCH₂C≡CH | — | O^{—} | H | H | — |
| 106 | W4 | —SCH₂C≡CCH₃ | — | O^{—} | H | H | — |
| 107 | W4 | —SCH₂CH₂C≡CH | — | O^{—} | H | H | — |
| 108 | W5 | H | H | O^{—} | H | H | — |
| 109 | W5 | Cl | H | O^{—} | H | H | — |
| 110 | W5 | F | H | O^{—} | H | H | — |
| 111 | W5 | —CH₃ | H | O^{—} | H | H | — |
| 112 | W5 | —C₂H₅ | H | O^{—} | H | H | — |
| 113 | W5 | —C₃H₇ | H | O^{—} | H | H | — |
| 114 | W5 | —C₄H₉ | H | O^{—} | H | H | — |
| 115 | W5 | —OCH₃ | H | O^{—} | H | H | — |
| 116 | W5 | —OC₂H₅ | H | O^{—} | H | H | — |
| 117 | W5 | —OC₃H₇ | —CH₃ | O^{—} | H | H | — |
| 118 | W5 | —OC₄H₉ | H | O^{—} | H | H | — |
| 119 | W5 | —OC₅H₁₁ | H | O^{—} | H | H | — |
| 120 | W5 | —OCH₂CH═CH₂ | H | O^{—} | H | H | — |
| 121 | W5 | —OCH₂C≡CCH₃ | H | O^{—} | H | H | — |
| 122 | W5 | —OCH₂CH₂C≡CH | H | O^{—} | H | H | — |
| 123 | W5 | —SCH₃ | H | O^{—} | H | H | — |
| 124 | W5 | —SC₂H₅ | H | O^{—} | H | H | — |
| 125 | W5 | —SC₃H₇ | H | O^{—} | H | H | — |
| 126 | W5 | —SC₄H₉ | H | O^{—} | H | H | — |
| 127 | W5 | —SC₅H₁₁ | H | O^{—} | H | H | — |
| 128 | W5 | —SC₅H₁₀CN | H | O^{—} | H | H | — |
| 129 | W5 | —SC₆H₁₃ | H | O^{—} | H | H | — |
| 130 | W5 | —SC₆H₁₂CN | H | O^{—} | H | H | — |
| 131 | W5 | —SCH₂CH═CH₂ | H | O^{—} | H | H | — |
| 132 | W5 | —SCH₂C≡CH | H | O^{—} | H | H | — |
| 133 | W5 | —SCH₂C≡CCH₃ | H | O^{—} | H | H | — |
| 134 | W5 | —SCH₂CH₂C≡CH | H | O^{—} | H | H | — |
| 135 | W5 | Cl | —C(O)OC₂H₅ | O^{—} | H | H | — |
| 136 | W5 | Cl | —CH₂Ph | O^{—} | H | H | — |
| 137 | W6 | H | H | O^{—} | H | H | — |
| 138 | W6 | Cl | H | O^{—} | H | H | — |
| 139 | W6 | F | H | O^{—} | H | H | — |
| 140 | W6 | —CH₃ | H | O^{—} | H | H | — |
| 141 | W6 | —OCH₂C≡CCH₃ | H | O^{—} | H | H | — |
| 142 | W6 | H | —CH₃ | O^{—} | H | H | — |
| 143 | W6 | Cl | —CH₃ | O^{—} | H | H | — |
| 144 | W6 | F | —CH₃ | O^{—} | H | H | — |
| 145 | W6 | —CH₃ | —CH₃ | O^{—} | H | H | — |
| 146 | W6 | —OCH₂C≡CCH₃ | —CH₃ | O^{—} | H | H | — |
| 147 | W7 | H | H | O^{—} | H | H | — |
| 148 | W7 | Cl | H | O^{—} | H | H | — |
| 149 | W7 | Cl | H | O^{—} | 4-Cl | H | — |
| 150 | W7 | F | H | O^{—} | H | H | — |
| 151 | W7 | —CH₃ | H | O^{—} | H | H | — |
| 152 | W7 | —OCH₂C≡CH | H | O^{—} | H | H | — |
| 153 | W7 | H | —CH₃ | O^{—} | H | H | — |
| 154 | W7 | Cl | —CH₃ | O^{—} | H | H | — |
| 155 | W7 | Cl | —CH₃ | O^{—} | H | H | — |
| 156 | W7 | F | —CH₃ | O^{—} | H | H | — |
| 157 | W7 | —CH₃ | —CH₃ | O^{—} | H | H | — |
| 158 | W7 | —OCH₂C≡CH | —CH₃ | O^{—} | H | H | — |
| 159 | W7 | —CH₃ | —CH₃ | O^{—} | 2-Cl | H | — |
| 160 | W7 | —CH₃ | —CH₃ | O^{—} | 2-F | H | — |
| 161 | W7 | —CH₃ | —CH₃ | O^{—} | 2-CH₃ | H | — |
| 162 | W7 | —CH₃ | —CH₃ | O^{—} | 4-Cl | H | — |
| 163 | W7 | —CH₃ | —CH₃ | O^{—} | 4-F | H | — |
| 164 | W7 | —CH₃ | —CH₃ | O^{—} | 4-CH₃ | H | — |
| 165 | W7 | —CH₃ | —CH₃ | O^{—} | 6-Cl | H | — |
| 166 | W7 | —CH₃ | —CH₃ | O^{—} | 6-F | H | — |
| 167 | W7 | —CH₃ | —CH₃ | O^{—} | 6-CH₃ | H | — |
| 168 | W7 | —CH₃ | —CH₃ | O^{—} | 2-Cl | 2-Cl | — |
| 169 | W7 | —CH₃ | —CH₃ | O^{—} | 2-F | 2-F | — |
| 170 | W7 | —CH₃ | —CH₃ | O^{—} | 2-CH₃ | 2-CH₃ | — |
| 171 | W7 | —CH₃ | —CH₃ | O^{—} | 6-Cl | 6-Cl | — |
| 172 | W7 | —CH₃ | —CH₃ | O^{—} | 6-F | 6-F | — |
| 173 | W7 | —CH₃ | —CH₃ | O^{—} | 6-CH₃ | 6-CH₃ | — |
| 174 | W8 | H | — | O^{—} | H | H | — |
| 175 | W8 | H | — | O^{—} | H | H | — |
| 176 | W8 | Cl | — | O^{—} | H | H | — |
| 177 | W8 | F | — | O^{—} | H | H | — |
| 178 | W8 | —CH₃ | — | O^{—} | H | H | — |
| 179 | W8 | —OCH₂C≡CH | — | O^{—} | H | H | — |
| 180 | W9 | H | H | O^{—} | H | H | 0 |
| 181 | W9 | Cl | H | O^{—} | H | H | 0 |
| 182 | W9 | F | H | O^{—} | H | H | 0 |
| 183 | W9 | —CH₃ | H | O^{—} | H | H | 0 |
| 184 | W9 | —C₂H₅ | H | O^{—} | H | H | 0 |
| 185 | W9 | —OCH₃ | H | O^{—} | H | H | 0 |
| 186 | W9 | —CH₂OCH | H | O^{—} | H | H | 0 |
| 187 | W9 | —OCH₂C≡CH | H | O^{—} | H | H | 0 |
| 188 | W9 | H | H | O^{—} | H | H | 1 |
| 189 | W9 | Cl | H | O^{—} | H | H | 1 |
| 190 | W9 | F | H | O^{—} | H | H | 1 |
| 191 | W9 | —CH₃ | H | O^{—} | H | H | 1 |
| 192 | W9 | —C₂H₅ | H | O^{—} | H | H | 1 |
| 193 | W9 | —OCH₃ | H | O^{—} | H | H | 1 |
| 194 | W9 | —CH₂OCH | H | O^{—} | H | H | 1 |
| 195 | W9 | —OCH₂C≡CH | H | O^{—} | H | H | 1 |
| 196 | W9 | H | —CH₃ | O^{—} | H | H | 0 |
| 197 | W9 | Cl | —CH₃ | O^{—} | H | H | 0 |
| 198 | W9 | F | —CH₃ | O^{—} | H | H | 0 |
| 199 | W9 | —CH₃ | —CH₃ | O^{—} | H | H | 0 |
| 200 | W9 | —C₂H₅ | —CH₃ | O^{—} | H | H | 0 |
| 201 | W9 | —OCH₃ | —CH₃ | O^{—} | H | H | 0 |
| 202 | W9 | —CH₂OCH | —CH₃ | O^{—} | H | H | 0 |
| 203 | W9 | —OCH₂C≡CH | —CH₃ | O^{—} | H | H | 0 |
| 204 | W9 | H | —CH₃ | O^{—} | H | H | 1 |
| 205 | W9 | Cl | —CH₃ | O^{—} | H | H | 1 |
| 206 | W9 | F | —CH₃ | O^{—} | H | H | 1 |
| 207 | W9 | —CH₃ | —CH₃ | O^{—} | H | H | 1 |
| 208 | W9 | —C₂H₅ | —CH₃ | O^{—} | H | H | 1 |
| 209 | W9 | —OCH₃ | —CH₃ | O^{—} | H | H | 1 |
| 210 | W9 | —CH₂OCH | —CH₃ | O^{—} | H | H | 1 |
| 211 | W9 | —OCH₂C≡CH | —CH₃ | O^{—} | H | H | 1 |
| 212 | W9 | H | —CH₃ | O^{—} | H | H | 2 |
| 213 | W9 | Cl | —CH₃ | O^{—} | H | H | 2 |
| 214 | W9 | F | —CH₃ | O^{—} | H | H | 2 |
| 215 | W9 | —CH₃ | —CH₃ | O^{—} | H | H | 2 |
| 216 | W9 | —C₂H₅ | —CH₃ | O^{—} | H | H | 2 |
| 217 | W9 | —OCH₃ | —CH₃ | O^{—} | H | H | 2 |
| 218 | W9 | —CH₂OCH | —CH₃ | O^{—} | H | H | 2 |
| 219 | W9 | —OCH₂C≡CH | —CH₃ | O^{—} | H | H | 2 |
| 220 | W10 | H | —CH₃ | O^{—} | H | H | 0 |
| 221 | W10 | Cl | —CH₃ | O^{—} | H | H | 0 |
| 222 | W10 | F | —CH₃ | O^{—} | H | H | 0 |
| 223 | W10 | —CH₃ | —CH₃ | O^{—} | H | H | 0 |
| 224 | W10 | —C₂H₅ | —CH₃ | O^{—} | H | H | 0 |
| 225 | W10 | —OCH₃ | —CH₃ | O^{—} | H | H | 0 |
| 226 | W10 | —CH₂OCH | —CH₃ | O^{—} | H | H | 0 |
| 227 | W10 | —OCH₂C≡CH | —CH₃ | O^{—} | H | H | 0 |
| 228 | W10 | H | —CH₃ | O^{—} | H | H | 1 |
| 229 | W10 | Cl | —CH₃ | O^{—} | H | H | 1 |
| 230 | W10 | F | —CH₃ | O^{—} | H | H | 1 |
| 231 | W10 | —CH₃ | —CH₃ | O^{—} | H | H | 1 |
| 232 | W10 | —C₂H₅ | —CH₃ | O^{—} | H | H | 1 |
| 233 | W10 | —OCH₃ | —CH₃ | O^{—} | H | H | 1 |
| 234 | W10 | —CH₂OCH | —CH₃ | O^{—} | H | H | 1 |
| 235 | W10 | —OCH₂C≡CH | —CH₃ | O^{—} | H | H | 1 |
| 236 | W10 | H | —CH₃ | O^{—} | H | H | 2 |
| 237 | W10 | Cl | —CH₃ | O^{—} | H | H | 2 |
| 238 | W10 | F | —CH₃ | O^{—} | H | H | 2 |
| 239 | W10 | —CH₃ | —CH₃ | O^{—} | H | H | 2 |
| 240 | W10 | —C₂H₅ | —CH₃ | O^{—} | H | H | 2 |
| 241 | W10 | —OCH₃ | —CH₃ | O^{—} | H | H | 2 |
| 242 | W10 | —CH₂OCH | —CH₃ | O^{—} | H | H | 2 |
| 243 | W10 | —OCH₂C≡CH | —CH₃ | O^{—} | H | H | 2 |
| 244 | W11 | H | —CH₃ | O^{—} | H | H | 0 |
| 245 | W11 | Cl | —CH₃ | O^{—} | H | H | 0 |
| 246 | W11 | F | —CH₃ | O^{—} | H | H | 0 |
| 247 | W11 | —CH₃ | —CH₃ | O^{—} | H | H | 0 |
| 248 | W11 | —C₂H₅ | —CH₃ | O^{—} | H | H | 0 |
| 249 | W11 | —OCH₃ | —CH₃ | O^{—} | H | H | 0 |
| 250 | W11 | —CH₂OCH | —CH₃ | O^{—} | H | H | 0 |
| 251 | W11 | —OCH₂C≡CH | —CH₃ | O^{—} | H | H | 0 |
| 252 | W11 | H | —CH₃ | O^{—} | H | H | 1 |
| 253 | W11 | Cl | —CH₃ | O^{—} | H | H | 1 |
| 254 | W11 | F | —CH₃ | O^{—} | H | H | 1 |
| 255 | W11 | —CH₃ | —CH₃ | O^{—} | H | H | 1 |
| 256 | W11 | —C₂H₅ | —CH₃ | O^{—} | H | H | 1 |
| 257 | W11 | —OCH₃ | —CH₃ | O^{—} | H | H | 1 |
| 258 | W11 | —CH₂OCH | —CH₃ | O^{—} | H | H | 1 |
| 259 | W11 | —OCH₂C≡CH | —CH₃ | O^{—} | H | H | 1 |
| 260 | W11 | H | —CH₃ | O^{—} | H | H | 2 |
| 261 | W11 | Cl | —CH₃ | O^{—} | H | H | 2 |
| 262 | W11 | F | —CH₃ | O^{—} | H | H | 2 |
| 263 | W11 | —CH₃ | —CH₃ | O^{—} | H | H | 2 |
| 264 | W11 | —C₂H₅ | —CH₃ | O^{—} | H | H | 2 |
| 265 | W11 | —OCH₃ | —CH₃ | O^{—} | H | H | 2 |
| 266 | W11 | —CH₂OCH | —CH₃ | O^{—} | H | H | 2 |
| 267 | W11 | —OCH₂C≡CH | —CH₃ | O^{—} | H | H | 2 |
| 268 | W12 | H | H | O^{—} | H | H | — |
| 269 | W12 | H | —CH₃ | O^{—} | H | H | — |
| 270 | W12 | H | —C₂H₅ | O^{—} | H | H | — |
| 271 | W12 | H | —OCH₃ | O^{—} | H | H | — |
| 272 | W12 | H | —CH₂OCH | O^{—} | H | H | — |
| 273 | W12 | H | —OCH₂C≡CH | O^{—} | H | H | — |
| 274 | W12 | H | —CO₂C₄H₉ | O^{—} | H | H | — |
| 275 | W12 | Cl | H | O^{—} | H | H | — |
| 276 | W12 | Cl | —CH₃ | O^{—} | H | H | — |
| 277 | W12 | Cl | —C₂H₅ | O^{—} | H | H | — |
| 278 | W12 | Cl | —OCH₃ | O^{—} | H | H | — |
| 279 | W12 | Cl | —CH₂OCH | O^{—} | H | H | — |
| 280 | W12 | Cl | —OCH₂C≡CH | O^{—} | H | H | — |
| 281 | W12 | Cl | —CO₂C₄H₉ | O^{—} | H | H | — |
| 282 | W12 | F | H | O^{—} | H | H | — |
| 283 | W12 | F | —CH₃ | O^{—} | H | H | — |
| 284 | W12 | F | —C₂H₅ | O^{—} | H | H | — |
| 285 | W12 | F | —OCH₃ | O^{—} | H | H | — |
| 286 | W12 | F | —CH₂OCH | O^{—} | H | H | — |
| 287 | W12 | F | —OCH₂C≡CH | O^{—} | H | H | — |
| 288 | W12 | F | —CO₂C₄H₉ | O^{—} | H | H | — |
| 289 | W12 | —CH₃ | H | O^{—} | H | H | — |
| 290 | W12 | —CH₃ | —CH₃ | O^{—} | H | H | — |
| 291 | W12 | —CH₃ | —C₂H₅ | O^{—} | H | H | — |
| 292 | W12 | —CH₃ | —OCH₃ | O^{—} | H | H | — |
| 293 | W12 | —CH₃ | —CH₂OCH | O^{—} | H | H | — |
| 294 | W12 | —CH₃ | —OCH₂C≡CH | O^{—} | H | H | — |
| 295 | W12 | —CH₃ | —CO₂C₄H₉ | O^{—} | H | H | — |
| 296 | W12 | —OCH₃ | H | O^{—} | H | H | — |
| 297 | W12 | —OCH₃ | —CH₃ | O^{—} | H | H | — |
| 298 | W12 | —OCH₃ | —C₂H₅ | O^{—} | H | H | — |
| 299 | W12 | —OCH₃ | —OCH₃ | O^{—} | H | H | — |
| 300 | W12 | —OCH₃ | —CH₂OCH | O^{—} | H | H | — |
| 301 | W12 | —OCH₃ | —OCH₂C≡CH | O^{—} | H | H | — |
| 302 | W12 | —OCH₃ | —CO₂C₄H₉ | O^{—} | H | H | — |
| 303 | W12 | —CH₂OCH | H | O^{—} | H | H | — |
| 304 | W12 | —CH₂OCH | —CH₃ | O^{—} | H | H | — |
| 305 | W12 | —CH₂OCH | —C₂H₅ | O^{—} | H | H | — |
| 306 | W12 | —CH₂OCH | —OCH₃ | O^{—} | H | H | — |
| 307 | W12 | —CH₂OCH | —CH₂OCH | O^{—} | H | H | — |
| 308 | W12 | —CH₂OCH | —OCH₂C≡CH | O^{—} | H | H | — |
| 309 | W12 | —CH₂OCH | —CO₂C₄H₉ | O^{—} | H | H | — |
| 310 | W12 | —OCH₂C≡CH | H | O^{—} | H | H | — |
| 311 | W12 | —OCH₂C≡CH | —CH₃ | O^{—} | H | H | — |
| 312 | W12 | —OCH₂C≡CH | —C₂H₅ | O^{—} | H | H | — |
| 313 | W12 | —OCH₂C≡CH | —OCH₃ | O^{—} | H | H | — |
| 314 | W12 | —OCH₂C≡CH | —CH₂OCH | O^{—} | H | H | — |
| 314 | W12 | —OCH₂C≡CH | —OCH₂C≡CH | O^{—} | H | H | — |
| 316 | W12 | —OCH₂C≡CH | —CO₂C₄H₉ | O^{—} | H | H | — |
| 317 | W13 | H | —CH₂Ph | O^{—} | H | H | — |
| 318 | W13 | Cl | —CH₂Ph | O^{—} | H | H | — |
| 319 | W13 | F | —CH₂Ph | O^{—} | H | H | — |

where R is W4 and the five-membered heterocycle is X2, a 1,2,5-thiadiazol-3-yl

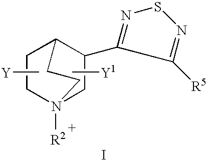

where R⁵, Y and Y¹ are hydrogen

| Cmpd | | | |
|---|---|---|---|
| No. | R² | R³ | R⁴ |
| 320 | —CH₃ | — | — |
| 321 | —C₂H₅ | — | — |
| 322 | —C₃H₇ | — | — |
| 323 | —C₄H₉ | — | — |
| 324 | —C₅H₁₁ | — | — |
| 325 | —C₆H₁₃ | — | — |
| 326 | —CH₂C₆H₅ | — | — |
| 327 | 4-FPhCH₂— | — | — |
| 328 | 4-ClPhCH₂— | — | — |
| 329 | 4-CH₃PhCH₂— | — | — |
| 330 | 4-CH₃OPhCH₂— | — | — |
| 331 | 3-ClPhCH₂— | — | — |
| 332 | 3-CH₃PhCH₂— | — | — |
| 333 | 3-(C₂H₅)PhCH₂— | — | — |
| 334 | 2-ClPhCH₂— | — | — |
| 335 | —OCH₃ | — | — |
| 336 | —OC₂H₅ | — | — |
| 337 | —OC₃H₇ | — | — |
| 338 | —OC₄H₉ | — | — |
| 339 | —OC₅H₁₁ | — | — |
| 340 | —OC₆H₁₃ | — | — |
| 341 | —OCH₂Ph | — | — |
| 342 | —CH₂CO₂CH₃ | — | — |
| 343 | —CH₂C(O)O^{—} | — | — |
| 344 | —C₂H₄CO₂CH₃ | — | — |
| 345 | —C₂H₄C(O)O^{—} | — | — |
| 346 | —OC₂H₄SCH₃ | — | — |
| 347 | —OC₂H₄S(O)CH₃ | — | — |
| 348 | —OC₂H₄SO₂CH₃ | — | — |
| 349 | —OC₂H₄PO₂OCH₃ | — | — |
| 350 | —OC₂H₄PO₂O^{—} | — | — |
| 351 | —OC(O)CH₃ | — | — |
| 352 | —OC(O)C₂H₅ | — | — |
| 353 | —OC(O)C₃H₇ | — | — |
| 354 | —OC(O)C₄H₉ | — | — |
| 355 | —OC(O)C₅H₁₁ | — | — |
| 356 | —OC(O)C₆H₁₃ | — | — |
| 357 | —OC(O)Ph | — | — |
| 358 | —OC(O)CH₂Ph | — | — |
| 359 | —OCO₂CH₃ | — | — |
| 360 | —OCO₂C₂H₅ | — | — |
| 361 | —OCO₂C₃H₇ | — | — |
| 362 | —OCO₂C₄H₉ | — | — |
| 363 | —OCO₂C₅H₁₁ | — | — |
| 364 | —OCO₂C₆H₁₃ | — | — |
| 365 | —OCO₂Ph | — | — |
| 366 | —OCO₂CH₂Ph | — | — |
| 367 | —OC(O)N(R³)(R⁴) | H | H |
| 368 | —OC(O)N(R³)(R⁴) | H | CH₃ |
| 369 | —OC(O)N(R³)(R⁴) | H | C₂H₅ |
| 370 | —OC(O)N(R³)(R⁴) | H | C₃H₇ |
| 371 | —OC(O)N(R³)(R⁴) | H | C₄H₉ |
| 372 | —OC(O)N(R³)(R⁴) | H | C₅H₁₁ |
| 373 | —OC(O)N(R³)(R⁴) | H | C₆H₁₃ |
| 374 | —OC(O)N(R³)(R⁴) | H | Ph |
| 375 | —OC(O)N(R³)(R⁴) | H | CH₂Ph |
| 376 | —OC(O)N(R³)(R⁴) | CH₃ | CH₃ |
| 377 | —OC(O)N(R³)(R⁴) | C₂H₅ | C₂H₅ |
| 378 | —OC(O)N(R³)(R⁴) | C₃H₇ | C₃H₇ |
| 379 | —OC(O)N(R³)(R⁴) | C₄H₉ | C₄H₉ |
| 380 | —OC(O)N(R³)(R⁴) | C₅H₁₁ | C₅H₁₁ |
| 381 | —OC(O)N(R³)(R⁴) | C₆H₁₃ | C₆H₁₃ |
| 382 | —OC(O)N(R³)(R⁴) | Ph | Ph |
| 383 | —OC(O)N(R³)(R⁴) | CH₂Ph | CH₂Ph |
| 384 | —OC(O)N(R³)(R⁴) | OCH₃ | OCH₃ |
| 385 | —OC(O)N(R³)(R⁴) | OC₂H₅ | OC₂H₅ |
| 386 | —OC(O)N(R³)(R⁴) | OC₃H₇ | OC₃H₇ |
| 387 | —OC(O)N(R³)(R⁴) | OC₄H₉ | OC₄H₉ |
| 388 | —OC(O)N(R³)(R⁴) | OC₅H₁₁ | OC₅H₁₁ |
| 389 | —OC(O)N(R³)(R⁴) | OC₆H₁₃ | OC₆H₁₃ |
| 390 | —OC(O)N(R³)(R⁴) | Oph | OPh |
| 391 | —OC(O)N(R³)(R⁴) | OCH₂Ph | OCH₂Ph |
| 392 | —OC(O)N(R³)(R⁴) | CH₃ | C₂H₅ |
| 393 | —OC(O)N(R³)(R⁴) | C₂H₅ | C₃H₇ |
| 394 | —OC(O)N(R³)(R⁴) | OCH₃ | CH₃ |

where the five-membered heterocycle is X4, a 1,2,4-oxadiazol-5-yl

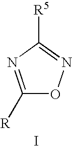

| Cmpd. | | | | | | |
|---|---|---|---|---|---|---|
| No. | R | R¹ | R² | R⁵ | Y | Y¹ |
| 395 | W1 | —CH₃ | O^{—} | —CH₃ | H | H |
| 396 | W3 | — | O^{—} | —CH₃ | H | H |
| 397 | W3 | — | O^{—} | —C₂H₅ | H | H |
| 398 | W3 | — | O^{—} | —OC₄H₉ | H | H |
| 399 | W4 | — | O^{—} | —CH₃ | H | H |
| 400 | W19 | — | O^{—} | —CH₃ | H | H |
| 401 | W20 | — | O^{—} | —CH₃ | H | H |

where the five-membered heterocycle is X12, a 1,2,3,4-tetraazol-2-yl

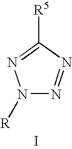

| Cmpd | | | | | | |
|---|---|---|---|---|---|---|
| No. | R | R¹ | R² | Y | Y¹ | R⁵ |
| 402¹ | W3 | — | O^{—} | H | H | —CH₃ |
| 403² | W3 | — | —OCH₃ | H | H | —CH₃ |
| 404³ | W3 | — | O^{—} | H | H | —CH₃ |
| 405 | W3 | — | O^{—} | H | H | —C₂H₅ |
| 406 | W3 | — | O^{—} | H | H | —NHC(═O)R⁹* |
| 407 | W4 | — | O^{—} | H | H | —CH₃ |
| 408 | W6 | H | O^{—} | H | H | —CH₃ |

where the five-membered heterocycle is X11, a 1,2,3,5-thiatriazolin-4-yl

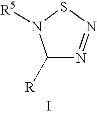

| Cmpd | | | | | | | |
|---|---|---|---|---|---|---|---|
| No. | R | R⁵ | R¹ | R² | Y | Y¹ | n |
| 409 | W1 | H | H | O^{—} | H | H | — |
| 410 | W1 | H | —CH₂C₆H₅ | O^{—} | H | H | — |
| 411 | W1 | H | —C(O)OC₂H₅ | O^{—} | H | H | — |
| 412 | W1 | H | —CH₃ | O^{—} | H | H | — |
| 413 | W1 | H | —CH₃ | O^{—} | 2-Cl | H | — |
| 414 | W1 | H | —CH₃ | O^{—} | 2-CH₃ | H | — |
| 415 | W1 | H | —CH₃ | O^{—} | 4-Cl | H | — |
| 416 | W1 | H | —CH₃ | O^{—} | 4-CH₃ | H | — |
| 417 | W1 | H | —CH₃ | O^{—} | 6-Cl | H | — |
| 418 | W1 | H | —CH₃ | O^{—} | 6-CH₃ | H | — |
| 419 | W1 | H | —CH₃ | O^{—} | 2-F | 2-F | — |
| 420 | W1 | H | —CH₃ | O^{—} | 2-CH₃ | 2-CH₃ | — |
| 421 | W1 | H | —CH₃ | O^{—} | 6-F | 6-F | — |
| 422 | W1 | H | —CH₃ | O^{—} | 6-CH₃ | 6-CH₃ | — |
| 423 | W1 | H | —C₂H₅ | O^{—} | H | H | — |
| 424 | W1 | H | —CH₂OCH₃ | O^{—} | H | H | — |
| 425 | W1 | —CH₃ | —CH₃ | O^{—} | H | H | — |
| 426 | W1 | —CH₃ | —CH₃ | O^{—} | 2-Cl | H | — |
| 427 | W1 | —CH₃ | —CH₃ | O^{—} | 2-F | H | — |
| 428 | W1 | —CH₃ | —CH₃ | O^{—} | 2-CH₃ | H | — |
| 429 | W1 | —CH₃ | —CH₃ | O^{—} | 4-Cl | H | — |
| 430 | W1 | —CH₃ | —CH₃ | O^{—} | 4-F | H | — |
| 431 | W1 | —CH₃ | —CH₃ | O^{—} | 4-CH₃ | H | — |
| 432 | W1 | —CH₃ | —CH₃ | O^{—} | 6-Cl | H | — |
| 433 | W1 | —CH₃ | —CH₃ | O^{—} | 6-F | H | — |
| 434 | W1 | —CH₃ | —CH₃ | O^{—} | 6-CH₃ | H | — |
| 435 | W1 | —CH₃ | —CH₃ | O^{—} | 2-Cl | 2-Cl | — |
| 436 | W1 | —CH₃ | —CH₃ | O^{—} | 2-F | 2-F | — |
| 437 | W1 | —CH₃ | —CH₃ | O^{—} | 2-CH₃ | 2-CH₃ | — |
| 438 | W1 | —CH₂CH═CH₂ | —CH₃ | O^{—} | 6-Cl | 6-Cl | — |
| 439 | W1 | —CH₂C≡CCH₃ | —CH₃ | O^{—} | 6-F | 6-F | — |
| 440 | W1 | —OCH₂C≡CH | —CH₃ | O^{—} | 6-CH₃ | 6-CH₃ | — |
| 441 | W1 | —CH₂CH₂C₆H₅ | —CH₃ | O^{—} | H | H | — |
| 442 | W1 | —OCH₃ | —CH₃ | O^{—} | H | H | — |
| 443 | W1 | —OC₂H₅ | —CH₃ | O^{—} | H | H | — |
| 444 | W1 | —OC₃H₇ | —CH₃ | O^{—} | H | H | — |
| 445 | W1 | 4-FPhO | —CH₃ | O^{—} | H | H | — |
| 446 | W1 | —OCH₂CH═CH₂ | —CH₃ | O^{—} | H | H | — |
| 447 | W1 | —OCH₂C≡CH | —CH₃ | O^{—} | H | H | — |
| 448 | W1 | —OCH₂C≡CCH₃ | —CH₃ | O^{—} | H | H | — |
| 449 | W1 | —SCH₃ | —CH₃ | O^{—} | H | H | — |
| 450 | W1 | —SC₂H₅ | —CH₃ | O^{—} | H | H | — |
| 451 | W1 | —SC₃H₇ | —CH₃ | O^{—} | H | H | — |
| 452 | W1 | —SC₄H₉ | —CH₃ | O^{—} | H | H | — |
| 453 | W1 | —SC₅H₁₁ | —CH₃ | O^{—} | H | H | — |
| 454 | W1 | —SC₅H₁₀CN | —CH₃ | O^{—} | H | H | — |
| 455 | W1 | —SCH₂CH═CH₂ | —CH₃ | O^{—} | H | H | — |
| 456 | W1 | —SCH₂C≡CH | —CH₃ | O^{—} | H | H | — |
| 457 | W1 | —CO₂C₄H₉ | —CH₃ | O^{—} | H | H | — |
| 458 | W3 | H | — | O^{—} | H | H | — |
| 459 | W3 | H | — | O^{—} | 2-F | H | — |
| 460 | W3 | H | — | O^{—} | 2-CH₃ | H | — |
| 461 | W3 | H | — | O^{—} | 4-Cl | H | — |
| 462 | W3 | H | — | O^{—} | 4-CH₃ | H | — |
| 463 | W3 | H | — | O^{—} | 6-Cl | H | — |
| 464 | W3 | H | — | O^{—} | 6-F | H | — |
| 465 | W3 | H | — | O^{—} | 6-CH₃ | H | — |
| 466 | W3 | H | — | O^{—} | 2-Cl | 2-Cl | — |
| 467 | W3 | H | — | O^{—} | 2-CH₃ | 2-CH₃ | — |
| 468 | W3 | H | — | O^{—} | 6-Cl | 6-Cl | — |
| 469 | W3 | H | — | O^{—} | 6-F | 6-F | — |
| 470 | W3 | —CH₃ | — | O^{—} | H | H | — |
| 471 | W3 | —OCH₂C≡CH | — | O^{—} | H | H | — |
| 472 | W4 | H | — | O^{—} | H | H | — |
| 473 | W4 | —OCH₃ | — | O^{—} | H | H | — |
| 474 | W4 | —OC₂H₅ | — | O^{—} | H | H | — |
| 475 | W4 | —CH₂CH═CH₂ | — | O^{—} | H | H | — |
| 476 | W4 | —CH₂C≡CH | — | O^{—} | H | H | — |
| 377 | W4 | —OCH₂CH≡CH₂ | — | O^{—} | H | H | — |
| 478 | W4 | —OCH₂C≡CH | — | O^{—} | H | H | — |
| 479 | W4 | —OCH₂C≡CCH₃ | — | O^{—} | H | H | — |
| 480 | W4 | —OCH₂CH₂C≡CH | — | O^{—} | H | H | — |
| 481 | W4 | —SCH₃ | — | O^{—} | H | H | — |
| 482 | W4 | —SC₂H₅ | — | O^{—} | H | H | — |
| 483 | W4 | —SC₃H₇ | — | O^{—} | H | H | — |
| 484 | W4 | —SC₄H₉ | — | O^{—} | H | H | — |
| 485 | W4 | —SC₆H₁₃ | — | O^{—} | H | H | — |
| 486 | W4 | —SC₆H₁₂CN | — | O^{—} | H | H | — |
| 487 | W4 | —SCH₂CH═CH₂ | — | O^{—} | H | H | — |
| 488 | W4 | —SCH₂C≡CH | — | O^{—} | H | H | — |
| 489 | W4 | —SCH₂C≡CCH₃ | — | O^{—} | H | H | — |
| 490 | W4 | —SCH₂CH₂C≡CH | — | O^{—} | H | H | — |
| 491 | W5 | H | H | O^{—} | H | H | — |
| 492 | W5 | —CH₃ | H | O^{—} | H | H | — |
| 493 | W5 | —C₂H₅ | H | O^{—} | H | H | — |
| 494 | W5 | —C₃H₇ | H | O^{—} | H | H | — |
| 495 | W5 | —C₄H₉ | H | O^{—} | H | H | — |
| 496 | W5 | —OCH₃ | H | O^{—} | H | H | — |
| 497 | W5 | —OC₂H₅ | H | O^{—} | H | H | — |
| 498 | W5 | —OC₃H₇ | —CH₃ | O^{—} | H | H | — |
| 499 | W5 | —OC₄H₉ | H | O^{—} | H | H | — |
| 500 | W5 | —OC₅H₁₁ | H | O^{—} | H | H | — |
| 501 | W5 | —OCH₂CH═CH₂ | H | O^{—} | H | H | — |
| 502 | W5 | —OCH₂C≡CCH₃ | H | O^{—} | H | H | — |
| 503 | W5 | —OCH₂CH₂C≡CH | H | O^{—} | H | H | — |
| 504 | W5 | —SCH₃ | H | O^{—} | H | H | — |
| 505 | W5 | —SC₂H₅ | H | O^{—} | H | H | — |
| 506 | W5 | —SC₃H₇ | H | O^{—} | H | H | — |
| 507 | W5 | —SC₄H₉ | H | O^{—} | H | H | — |
| 508 | W5 | —SC₅H₁₁ | H | O^{—} | H | H | — |
| 509 | W5 | —SC₅H₁₀CN | H | O^{—} | H | H | — |
| 510 | W5 | —SC₆H₁₃ | H | O^{—} | H | H | — |
| 511 | W5 | —SC₆H₁₂CN | H | O^{—} | H | H | — |
| 512 | W5 | —SCH₂CH═CH₂ | H | O^{—} | H | H | — |
| 513 | W5 | —SCH₂C≡CH | H | O^{—} | H | H | — |
| 514 | W5 | —SCH₂C≡CCH₃ | H | O^{—} | H | H | — |
| 515 | W5 | —SCH₂CH₂C≡CH | H | O^{—} | H | H | — |
| 516 | W5 | —CH₂CH═CH₂ | —CO₂C₂H₅ | O^{—} | H | H | — |
| 517 | W5 | —CH₂C≡CH | —CH₂Ph | O^{—} | H | H | — |
| 518 | W6 | H | H | O^{—} | H | H | — |
| 519 | W6 | —CH₃ | H | O^{—} | H | H | — |
| 520 | W6 | —OCH₂C≡CCH₃ | H | O^{—} | H | H | — |
| 521 | W6 | H | —CH₃ | O^{—} | H | H | — |
| 522 | W6 | —CH₃ | —CH₃ | O^{—} | H | H | — |
| 523 | W6 | —OCH₂C≡CCH₃ | —CH₃ | O^{—} | H | H | — |
| 524 | W7 | H | H | O^{—} | H | H | — |
| 525 | W7 | —CH₃ | H | O^{—} | H | H | — |
| 526 | W7 | —OCH₂C≡CH | H | O^{—} | H | H | — |
| 527 | W7 | H | —CH₃ | O^{—} | H | H | — |
| 528 | W7 | —CH₃ | —CH₃ | O^{—} | H | H | — |
| 529 | W7 | —OCH₂C≡CH | —CH₃ | O^{—} | H | H | — |
| 530 | W7 | —CH₃ | —CH₃ | O^{—} | 2-Cl | H | — |
| 531 | W7 | —CH₃ | —CH₃ | O^{—} | 2-F | H | — |
| 532 | W7 | —CH₃ | —CH₃ | O^{—} | 2-CH₃ | H | — |
| 533 | W7 | —CH₃ | —CH₃ | O^{—} | 4-Cl | H | — |
| 534 | W7 | —CH₃ | —CH₃ | O^{—} | 4-F | H | — |
| 535 | W7 | —CH₃ | —CH₃ | O^{—} | 4-CH₃ | H | — |
| 536 | W7 | —CH₃ | —CH₃ | O^{—} | 6-Cl | H | — |
| 537 | W7 | —CH₃ | —CH₃ | O^{—} | 6-F | H | — |
| 538 | W7 | —CH₃ | —CH₃ | O^{—} | 6-CH₃ | H | — |
| 539 | W7 | —CH₃ | —CH₃ | O^{—} | 2-Cl | 2-Cl | — |
| 540 | W7 | —CH₃ | —CH₃ | O^{—} | 2-F | 2-F | — |
| 541 | W7 | —CH₃ | —CH₃ | O^{—} | 2-CH₃ | 2-CH₃ | — |
| 542 | W7 | —CH₃ | —CH₃ | O^{—} | 6-Cl | 6-Cl | — |
| 543 | W7 | —CH₃ | —CH₃ | O^{—} | 6-F | 6-F | — |
| 544 | W7 | —CH₃ | —CH₃ | O^{—} | 6-CH₃ | 6-CH₃ | — |
| 545 | W8 | H | — | O^{—} | H | H | — |
| 546 | W8 | H | — | O^{—} | H | H | — |
| 547 | W8 | —CH₃ | — | O^{—} | H | H | — |
| 548 | W8 | —OCH₂C≡CH | — | O^{—} | H | H | — |
| 549 | W9 | H | H | O^{—} | H | H | 0 |
| 550 | W9 | —CH₃ | H | O^{—} | H | H | 0 |
| 551 | W9 | —C₂H₅ | H | O^{—} | H | H | 0 |
| 552 | W9 | —OCH₃ | H | O^{—} | H | H | 0 |
| 553 | W9 | —CH₂OCH | H | O^{—} | H | H | 0 |
| 554 | W9 | —OCH₂C≡CH | H | O^{—} | H | H | 0 |
| 555 | W9 | H | H | O^{—} | H | H | 1 |
| 556 | W9 | —CH₃ | H | O^{—} | H | H | 1 |
| 557 | W9 | —C₂H₅ | H | O^{—} | H | H | 1 |
| 558 | W9 | —OCH₃ | H | O^{—} | H | H | 1 |
| 559 | W9 | —CH₂OCH | H | O^{—} | H | H | 1 |
| 560 | W9 | —OCH₂C≡CH | H | O^{—} | H | H | 1 |
| 561 | W9 | H | —CH₃ | O^{—} | H | H | 0 |
| 562 | W9 | —CH₃ | —CH₃ | O^{—} | H | H | 0 |
| 563 | W9 | —C₂H₅ | —CH₃ | O^{—} | H | H | 0 |
| 564 | W9 | —OCH₃ | —CH₃ | O^{—} | H | H | 0 |
| 565 | W9 | —CH₂OCH | —CH₃ | O^{—} | H | H | 0 |
| 566 | W9 | —OCH₂C≡CH | —CH₃ | O^{—} | H | H | 0 |
| 567 | W9 | H | —CH₃ | O^{—} | H | H | 1 |
| 568 | W9 | —CH₃ | —CH₃ | O^{—} | H | H | 1 |
| 569 | W9 | —C₂H₅ | —CH₃ | O^{—} | H | H | 1 |
| 570 | W9 | —OCH₃ | —CH₃ | O^{—} | H | H | 1 |
| 571 | W9 | —CH₂OCH | —CH₃ | O^{—} | H | H | 1 |
| 572 | W9 | —OCH₂C≡CH | —CH₃ | O^{—} | H | H | 1 |
| 573 | W9 | H | —CH₃ | O^{—} | H | H | 2 |
| 574 | W9 | —CH₃ | —CH₃ | O^{—} | H | H | 2 |
| 575 | W9 | —C₂H₅ | —CH₃ | O^{—} | H | H | 2 |
| 576 | W9 | —OCH₃ | —CH₃ | O^{—} | H | H | 2 |
| 577 | W9 | —CH₂OCH | —CH₃ | O^{—} | H | H | 2 |
| 578 | W9 | —OCH₂C≡CH | —CH₃ | O^{—} | H | H | 2 |
| 579 | W10 | H | —CH₃ | O^{—} | H | H | 0 |
| 580 | W10 | —CH₃ | —CH₃ | O^{—} | H | H | 0 |
| 581 | W10 | —C₂H₅ | —CH₃ | O^{—} | H | H | 0 |
| 582 | W10 | —OCH₃ | —CH₃ | O^{—} | H | H | 0 |
| 583 | W10 | —CH₂OCH | —CH₃ | O^{—} | H | H | 0 |
| 584 | W10 | —OCH₂C≡CH | —CH₃ | O^{—} | H | H | 0 |
| 585 | W10 | —CH₃ | —CH₃ | O^{—} | H | H | 1 |
| 586 | W10 | —C₂H₅ | —CH₃ | O^{—} | H | H | 1 |
| 587 | W10 | —OCH₃ | —CH₃ | O^{—} | H | H | 1 |
| 588 | W10 | —CH₂OCH | —CH₃ | O^{—} | H | H | 1 |
| 589 | W10 | —OCH₂C≡CH | —CH₃ | O^{—} | H | H | 1 |
| 590 | W10 | H | —CH₃ | O^{—} | H | H | 2 |
| 591 | W10 | —CH₃ | —CH₃ | O^{—} | H | H | 2 |
| 592 | W10 | —C₂H₅ | —CH₃ | O^{—} | H | H | 2 |
| 593 | W10 | —OCH₃ | —CH₃ | O^{—} | H | H | 2 |
| 594 | W10 | —CH₂OCH | —CH₃ | O^{—} | H | H | 2 |
| 595 | W10 | —OCH₂C≡CH | —CH₃ | O^{—} | H | H | 2 |
| 596 | W11 | H | —CH₃ | O^{—} | H | H | 0 |
| 597 | W11 | —CH₃ | —CH₃ | O^{—} | H | H | 0 |
| 598 | W11 | —C₂H₅ | —CH₃ | O^{—} | H | H | 0 |
| 599 | W11 | —OCH₃ | —CH₃ | O^{—} | H | H | 0 |
| 600 | W11 | —CH₂OCH | —CH₃ | O^{—} | H | H | 0 |
| 601 | W11 | —CH₂C≡CH | —CH₃ | O^{—} | H | H | 0 |
| 602 | W11 | H | —CH₃ | O^{—} | H | H | 1 |
| 603 | W11 | —CH₃ | —CH₃ | O^{—} | H | H | 1 |
| 604 | W11 | —C₂H₅ | —CH₃ | O^{—} | H | H | 1 |
| 605 | W11 | —OCH₃ | —CH₃ | O^{—} | H | H | 1 |
| 606 | W11 | —CH₂OCH | —CH₃ | O^{—} | H | H | 1 |
| 607 | W11 | —OCH₂C≡CH | —CH₃ | O^{—} | H | H | 1 |
| 608 | W11 | H | —CH₃ | O^{—} | H | H | 2 |
| 609 | W11 | —CH₃ | —CH₃ | O^{—} | H | H | 2 |
| 610 | W11 | —C₂H₅ | —CH₃ | O^{—} | H | H | 2 |
| 611 | W11 | —OCH₃ | —CH₃ | O^{—} | H | H | 2 |
| 612 | W11 | —CH₂OCH | —CH₃ | O^{—} | H | H | 2 |
| 613 | W11 | —OCH₂C≡CH | —CH₃ | O^{—} | H | H | 2 |
| 614 | W12 | H | H | O^{—} | H | H | — |
| 615 | W12 | H | —CH₃ | O^{—} | H | H | — |
| 616 | W12 | H | —C₂H₅ | O^{—} | H | H | — |
| 617 | W12 | H | —OCH₃ | O^{—} | H | H | — |
| 618 | W12 | H | —CH₂OCH | O^{—} | H | H | — |
| 619 | W12 | H | —OCH₂C≡CH | O^{—} | H | H | — |
| 620 | W12 | H | —CO₂C₄H₉ | O^{—} | H | H | — |
| 621 | W12 | —CH₃ | H | O^{—} | H | H | — |
| 622 | W12 | —CH₃ | —CH₃ | O^{—} | H | H | — |
| 623 | W12 | —CH₃ | —C₂H₅ | O^{—} | H | H | — |
| 624 | W12 | —CH₃ | —OCH₃ | O^{—} | H | H | — |
| 625 | W12 | —CH₃ | —CH₂OCH | O^{—} | H | H | — |
| 626 | W12 | —CH₃ | —OCH₂C≡CH | O^{—} | H | H | — |
| 627 | W12 | —CH₃ | —CO₂C₄H₉ | O^{—} | H | H | — |
| 628 | W12 | —OCH₃ | H | O^{—} | H | H | — |
| 629 | W12 | —OCH₃ | —CH₃ | O^{—} | H | H | — |
| 630 | W12 | —OCH₃ | —C₂H₅ | O^{—} | H | H | — |
| 631 | W12 | —OCH₃ | —OCH₃ | O^{—} | H | H | — |
| 632 | W12 | —OCH₃ | —CH₂OCH | O^{—} | H | H | — |
| 633 | W12 | —OCH₃ | —OCH₂C≡CH | O^{—} | H | H | — |
| 634 | W12 | —OCH₃ | —CO₂C₄H₉ | O^{—} | H | H | — |
| 635 | W12 | —CH₂OCH | H | O^{—} | H | H | — |
| 636 | W12 | —CH₂OCH | —CH₃ | O^{—} | H | H | — |
| 637 | W12 | —CH₂OCH | —C₂H₅ | O^{—} | H | H | — |
| 638 | W12 | —CH₂OCH | —OCH₃ | O^{—} | H | H | — |
| 639 | W12 | —CH₂OCH | —CH₂OCH | O^{—} | H | H | — |
| 640 | W12 | —CH₂OCH | —OCH₂C≡CH | O^{—} | H | H | — |
| 641 | W12 | —CH₂OCH | —CO₂C₄H₉ | O^{—} | H | H | — |
| 642 | W12 | —CH₂CH═CH | H | O^{—} | H | H | — |
| 643 | W12 | —CH₂CH═CH | —CH₃ | O^{—} | H | H | — |
| 644 | W12 | —OCH₂C≡CH | —C₂H₅ | O^{—} | H | H | — |
| 645 | W12 | —OCH₂C≡CH | —OCH₃ | O^{—} | H | H | — |
| 646 | W12 | —OCH₂C≡CH | —CH₂OCH | O^{—} | H | H | — |
| 647 | W12 | —OCH₂C≡CH | —OCH₂C≡CH | O^{—} | H | H | — |
| 648 | W12 | —OCH₂C≡CH | —CO₂C₄H₉ | O^{—} | H | H | — |

where the five-membered heterocycle is X5, a 1,2,4-oxadiazol-3-yl

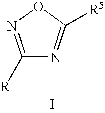

| Cmpd | | | | | | |
|---|---|---|---|---|---|---|
| No. | R | R¹ | R² | R⁵ | Y | Y¹ |
| 649 | W4 | — | O^{—} | —CH₃ | H | H |

where the five-membered heterocycle is X6, a 1,2,4-thiadiazol-5-yl

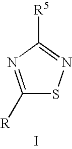

| Cmpd No. | R | R¹ | R² | R⁵ |
|---|---|---|---|---|
| 650 | W1 | —CH₃ | O^{—} | H |
| 651 | W1 | —CH₃ | O^{—} | —CH₃ |
| 652 | W1 | —CH₂Ph | O^{—} | —CH₃ |
| 653 | W3 | — | O^{—} | —CH₃ |
| 654 | W3 | — | O^{—} | H |

where the five-membered heterocycle is X34, a thien-3-yl

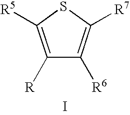

where R⁶ and R⁷ are hydrogen:

| Cmpd No. | R | R¹ | R² | R⁵ |
|---|---|---|---|---|
| 655 | W1 | —CH₃ | O^{—} | H |
| 656 | W1 | —CH₃ | O^{—} | —O(CH₂)₄CH₃ |
| 657 | W1 | —CH₃ | O^{—} | —OCH₂C≡CCH₃ |
| 658 | W1 | —CH₂Ph | O^{—} | —O(CH₂)₄CH₃ |
| 659 | W3 | — | O^{—} | H |
| 660 | W3 | — | O^{—} | —O(CH₂)₄CH₃ |
| 661 | W3 | — | O^{—} | —OCH₂C≡CCH₃ |
| 662 | W4 | — | O^{—} | H |
| 663 | W4 | — | O^{—} | —O(CH₂)₄CH₃ |
| 664 | W4 | — | O^{—} | —OCH₂C≡CCH₃ |

where the five-membered heterocycle is X21, a tetraazol-5-yl

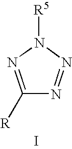

| Cmpd No. | R | R¹ | R² | R⁵ |
|---|---|---|---|---|
| 665 | W1 | —CH₃ | O^{—} | —CH₃ |
| 666 | W1 | —CH₃ | O^{—} | —C₂H₅ |
| 667 | W1 | —CH₃ | O^{—} | —CH₂C≡CCH₃ |
| 668 | W1 | —CH₂Ph | O^{—} | —CH₃ |
| 669 | W3 | — | O^{—} | —CH₃ |
| 670 | W3 | — | O^{—} | —C₂H₅ |
| 671 | W3 | — | O^{—} | —CH₂C≡CCH₃ |
| 672 | W4 | — | O^{—} | —CH₃ |
| 673 | W4 | — | O^{—} | —C₂H₅ |
| 674 | W4 | — | O^{—} | —CH₂C≡CCH₃ |

where the five-membered heterocycle is X18, a 1,2,3-triazol-4-yl

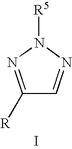

| Cmpd No. | R | R¹ | R² | R⁵ |
|---|---|---|---|---|
| 675 | W1 | —CH₃ | O^{—} | —CH₃ |
| 676 | W1 | —CH₃ | O^{—} | —C₂H₅ |
| 677 | W1 | —CH₃ | O^{—} | —CH₂C≡CCH₃ |
| 678 | W1 | —CH₃ | O^{—} | —CH₂Ph |
| 679 | W1 | —CH₂Ph | O^{—} | —CH₃ |
| 680 | W3 | — | O^{—} | —CH₃ |
| 681 | W3 | — | O^{—} | —C₂H₅ |
| 682 | W3 | — | O^{—} | —CH₂C≡CCH₃ |
| 683 | W3 | — | O^{—} | —CH₂Ph |

where the 5-membered heterocycle is X33, a 1,3,4-oxadiazol-2-yl

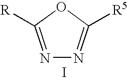

| Cmpd No. | R | R² | R⁵ |
|---|---|---|---|
| 685 | W20 | O^{—} | —CH₃ |

¹Iodide salt; ²Exo-isomer; ³Bromide salt; *R⁹ is —CH₃

Certain N-Substituted azacyclic compounds where the N-substituent is O⁻ (the N-oxides) of the present invention were tested to determine their translaminar characteristics as evidenced by activity against cotton aphid (Aphis gossypii) in comparison with their corresponding free amine derivatives. These tests were conducted in the following manner: For each compound tested, one cotton plant with two mature leaves was selected. On the top of one of the leaves a sticky material used for trapping insects was applied using a stamp of about 2.5 centimeters in diameter. The process was repeated on the bottom of the second leaf of the cotton plant. A solution of 500 ppm of test compound (dissolved in 1:1 acetone and water containing a small amount of surfactant) was then applied to the entire side of each leaf opposite the side stamped with the sticky material using a saturated cotton swab. Upon completion of the application of the test compounds, the cotton plants were maintained in a growth chamber for about 18 hours. After this time the leaves of the test plant were infested with a known number of cotton aphids by placing an infested leaf cutting from the cotton aphid colony directly over the sticky material on each leaf. The leaf cutting on the bottom of a leaf of the test plant was secured to the leaf with a pin. The treated and infested cotton plants were then maintained in a chamber, during which time they were evaluated at daily intervals of from one to up to eight days. A test compound was termed active (A) if the top and bottom of the leaves of the test plant were mostly free of aphids (80% to 100%) when compared to untreated controls. A test compound was termed somewhat active (SA) if 50% to 80% of the aphids were eliminated, and inactive (I) if less than 50% of the aphids were eliminated. The results of these tests are set forth below:

TABLE 2
Comparison of Translaminar Insecticidal Activity of N-Oxides of Certain
Azacyclic Derivatives and The Corresponding Free Amine Derivatives

| | Percent Mortality at Day After treatment (DAT) | | | | | | |
|---|---|---|---|---|---|---|---|
| Cmpd | 1 | | | | | | |
| No. | DAT | 2 DAT | 3 DAT | 4 DAT | 5 DAT | 6 DAT | 7 DAT |
| 6 | — | SA | SA | — | SA | SA | — |
| A | I | I | I | I | — | I | — |
| 396* | — | A | A | — | A | A | — |
| B | I | I | I | — | — | I | I |
| 397 | SA | — | SA | SA | SA | SA | — |
| C | I | — | I | I | I | I | — |
| 402 | A | A | A | — | — | A | A |
| D | — | — | — | | | SA | SA |
| 407 | I | — | SA | SA | SA | SA | — |
| E | I | — | I | I | I | I | — |

Rate of Application: 500 ppm;
I is less than 50% mortality when compared to the control;
SA is 50%-80% mortality when compared to the control;
A is 80%-100% mortality when compared to the control
*Compound 396 provided 100% mortality during the 7-day period

The N-oxides and their corresponding free amines that were tested are set forth below:

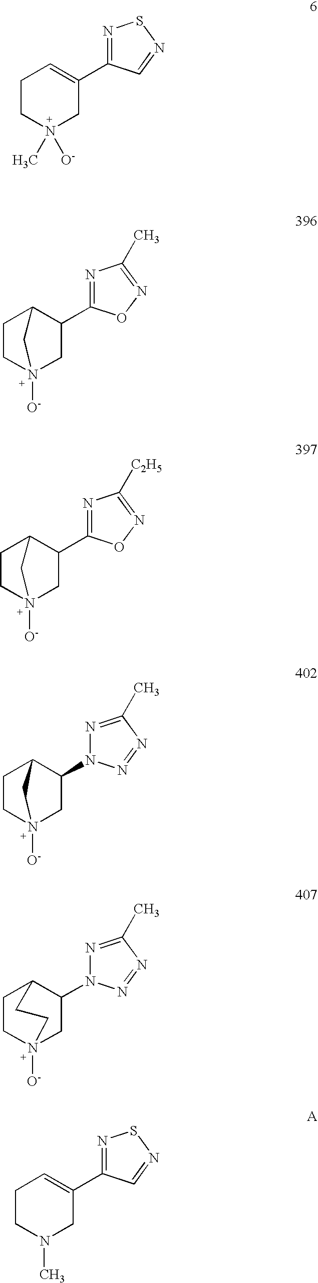

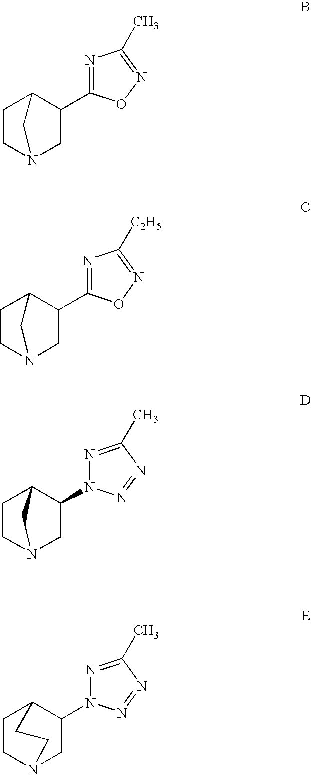

As taught in Table 2, above the N-oxide derivatives of the present invention exhibit improved insecticidal activity against cotton aphid when compared to their free amine analogs. The improved insecticidal activity is believed to be the result of the unexpected translaminar properties attributed to the N-oxides. For example, Compound 396 provided 100% mortality throughout the seven-day test period. In contrast, its free amine derivative, Compound B, provided less than 50% mortality of cotton aphid.

Certain N-Substituted azacyclic compounds where the N-substituent is O⁻ (the N-oxides) of the present invention were also tested to determine their residual insecticidal activity. These tests were conducted in the following manner:

For each rate of application of test compound, a 15 mL aliquot of test solution was prepared. Sufficient test compound was dissolved in 1.5 mL of acetone to provide an application rate as high as 1200 grams/Ha. Each solution was then added to 13.5 mL of water containing 300 ppm of a surfactant. There were four replicates for each rate of application of test compound, and all tests included a known chemical standard as well as a standard of water and untreated checks.

A maximum of 14 appropriately sized cotton plants for each rate of application and replicate were arranged in a 28 pot plastic flat and sprayed with the 15 mL sample of test compound using an traveling boom sprayer equipped with a cone spray tip at a rate of 30 gallons/acre under a pressure of 40-44 psi. The untreated checks were sprayed first, followed by the test compounds and standards, all in order of lowest to highest rates of application. Once the spraying was complete, the test plants were allowed to air-dry on the conveyor on which they were sprayed.

In the test to determine residual activity (0 Day Residual) one set of dry plants was infested with leaf cuttings covered with about 25 cotton aphids taken from cotton plants in an aphid colony. The cotton plants were then maintained in a greenhouse or in an atmosphere of simulated direct sunlight for 72 hours after which time cotton aphid mortality was determined.

A second set of dry test plants treated with test compounds were maintained for three days (3 Day Residual), then infested with cotton aphid. The infested plants were maintained and evaluated for cotton aphid mortality after 72 hours as set forth above. Other residual activity periods are optionally evaluated also, for example a 5 day residual.

At the end of the 72 hour exposure period the numbers of live insects were counted a percent mortality of aphids was calculated based on the number of live insects present and the number that were infested onto the plants. The results of these tests are set forth below:

TABLE 3
Residual Insecticidal Activity of Certain N-Oxide
Derivatives on Cotton Aphid

| | Rate of | Percent Mortality | | |
|---|---|---|---|---|
| Cmpd. No. | Appln (g/ha) | 0 DAT | 3 DAT¹ | 3 DAT² |
| 396 | 1120 | 100 | 100 | 100 |
| | 560 | 100 | 100 | 100 |
| | 224 | 100 | 98 | 99 |
| B | 1120 | 100 | 99 | 95 |
| | 560 | 100 | 84 | 49 |
| | 224 | 100 | 41 | 21 |

¹Test was maintained in a greenhouse environment
²Test was conducted in a simulated sunlight environment

TABLE 4
Residual Insecticidal Activity of Certain
N-Oxide Derivatives on Cotton Aphid

| | Rate of | Percent Mortality | | |
|---|---|---|---|---|
| Cmpd. No. | Appln (g/ha) | 0 DAT | 3 DAT¹ | 5 DAT² |
| 396 | 224 | 100 | 98 | 93 |
| | 112 | 100 | 70 | 86 |
| | 56 | 100 | 58 | 64 |
| 402 | 224 | 92 | 92 | 84 |
| | 112 | 84 | 84 | 70 |
| | 56 | 50 | 50 | 45 |

¹Test was conducted in a simulated sunlight environment
²Test was maintained in a greenhouse environment

As indicated by the results in Tables 3 and 4 above, the N-oxide derivatives of the present invention exhibit improved residual insecticidal activity against cotton aphid when compared to their free amine analogs, as a result of the unexpected translaminar properties attributed to the N-oxides. For example, in Table 3, Compound 396 provided 99% mortality in cotton aphid at a rate of application of 224 g/ha when the test plants were infested with the aphid at 3 days post-treatment. In contrast the corresponding free amine, Compound B, provided only 21% mortality at the same rate of application and time interval. In Table 4, Compound 396, as well as Compound 402, continue to provide unexpected residual insecticidal activity at the lower rates of application of 112 g/ha and 56 g/ha and a longer residual interval of 5 days.

While the invention has been described in detail and with reference to specific embodiments thereof, it will be apparent to one skilled in the art that various changes and modifications can be made therein without departing from the spirit and scope of the invention as defined by the following claims.

What is claimed is:

1. A pesticidal composition comprising a pesticidally effective amount of a compound of formula I in admixture with at least one agriculturally acceptable extender or adjuvant, wherein said compound of formula I is: 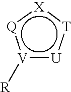
wherein
R is an azacycle selected from the following: 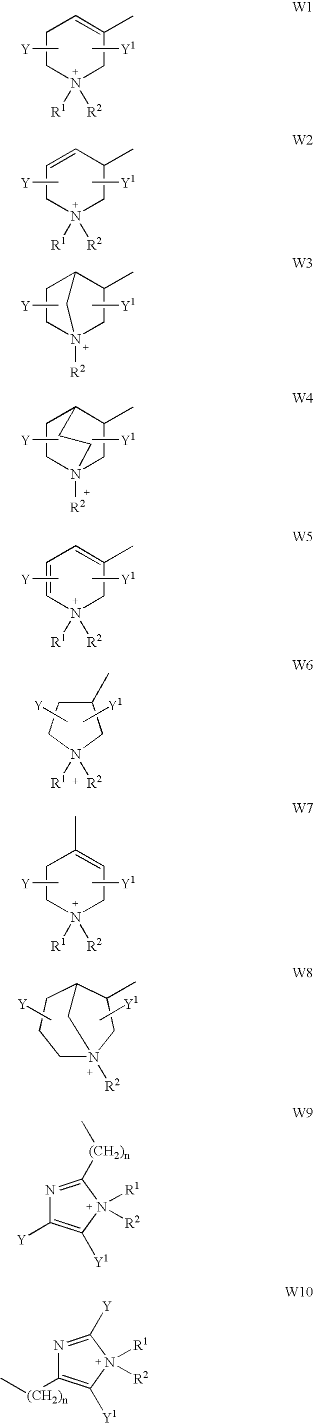 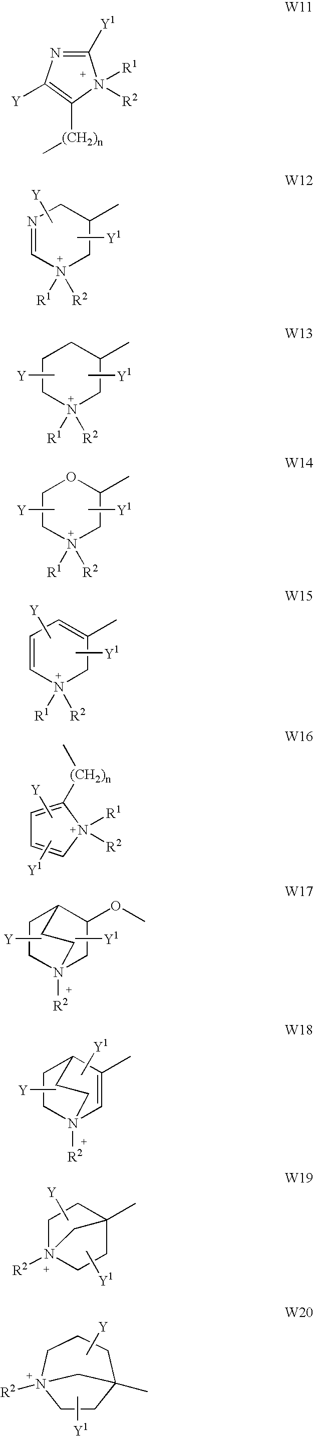 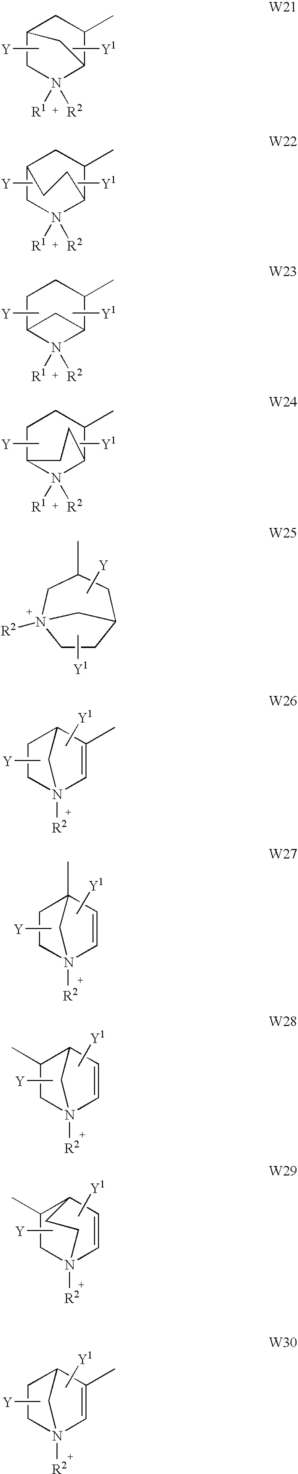 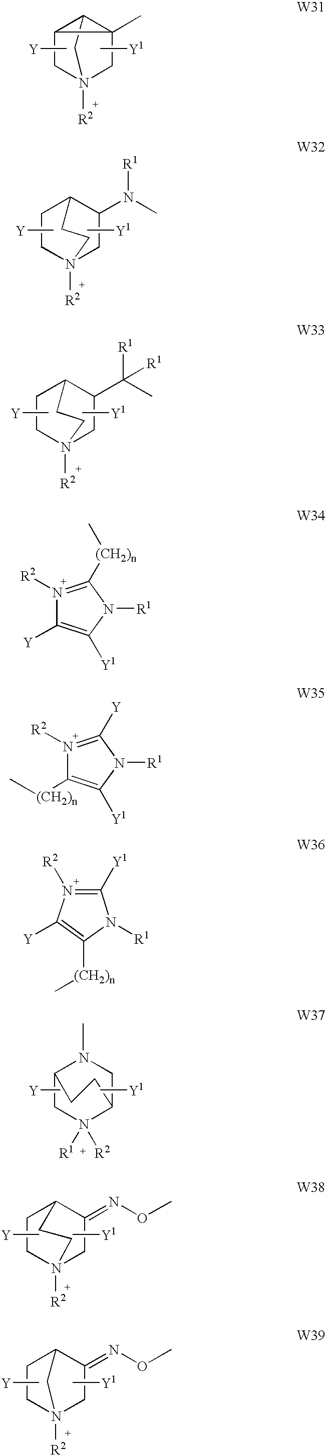 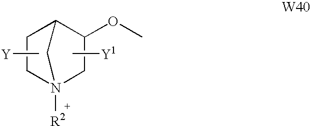
where
Y and Y¹ may be attached at the same or different positions, and are independently selected from hydrogen, halogen, hydroxy, cyano, nitro, amino, carboxyl, alkyl, haloalkyl, alkenyl, alkoxy, haloalkoxy, aminoalkoxy, alkylcarbonyl, haloalkylcarbonyl, alkoxycarbonyl, haloalkoxycarbonyl, arylalkyl, aryl, aryloxy, and heterocyclyl, where the aryl and heterocyclyl moieties may be optionally substituted with halogen, alkyl, haloalkyl, alkoxy, or haloalkoxy;
R¹ is selected from alkyl, haloalkyl, alkenyl, haloalkenyl, alkynyl, arylalkyl, and aryl; wherein the aryl may be optionally substituted with halogen, alkyl, haloalkyl, alkoxy, or haloalkoxy;
R² is selected from O⁻, forming an N-oxide; alkyl, alkoxy, haloalkyl, alkenyl, haloalkenyl, haloalkoxy, alkylcarbonyloxy, alkoxycarbonylalkyl, ⁻Ocarbonylalkyl, alkylthioalkyloxy, alkylsulfinylalkyloxy, alkylsulfonylalkyloxy, alkoxyphosphonylalkyloxy, ⁻Ophosphonylalkyloxy, alkoxyalkyl, arylalkyl, arylalkyloxy, arylcarbonyloxy, arylalkoxycarbonyloxy arylalkylcarbonyloxy, aryl, —OC(O)N(R³)(R⁴); wherein the aryl may be optionally substituted with halogen, alkyl, haloalkyl, alkoxy, or haloalkoxy moiety;
where
R³ and R⁴ are independently selected from hydrogen, alkyl, alkylcarbonyl, alkoxycarbonyl, alkoxyalkyl, aminoalkyl, aryl, arylalkyl, and carbonylamino; where the aryl may be optionally substituted with halogen, alkyl, haloalkyl, alkoxy, cyano, or haloalkoxy; and, 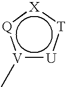
is a 5-membered heterocycle, wherein V is carbon or nitrogen; Q is carbon, nitrogen or oxygen; X is carbon, nitrogen, oxygen or sulfur, T is carbon, nitrogen, oxygen or C(═O); and U is carbon, nitrogen, oxygen or sulfur, wherein said 5-membered heterocycle is selected from the following; 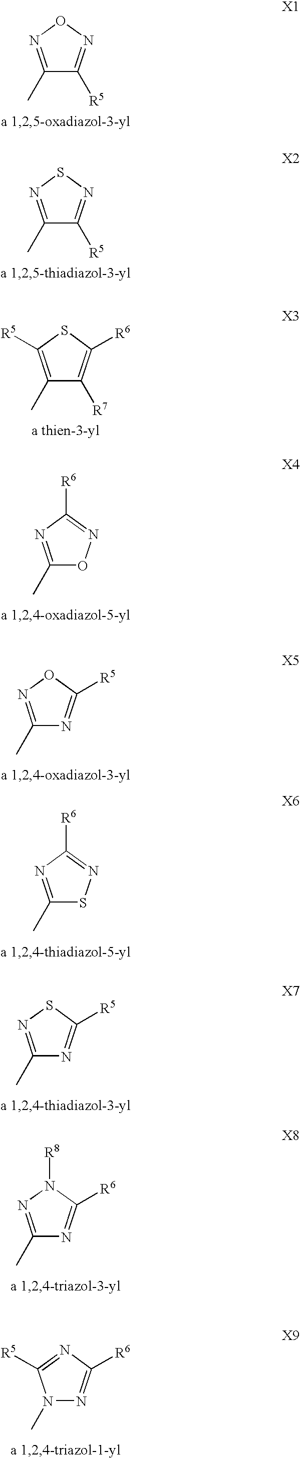 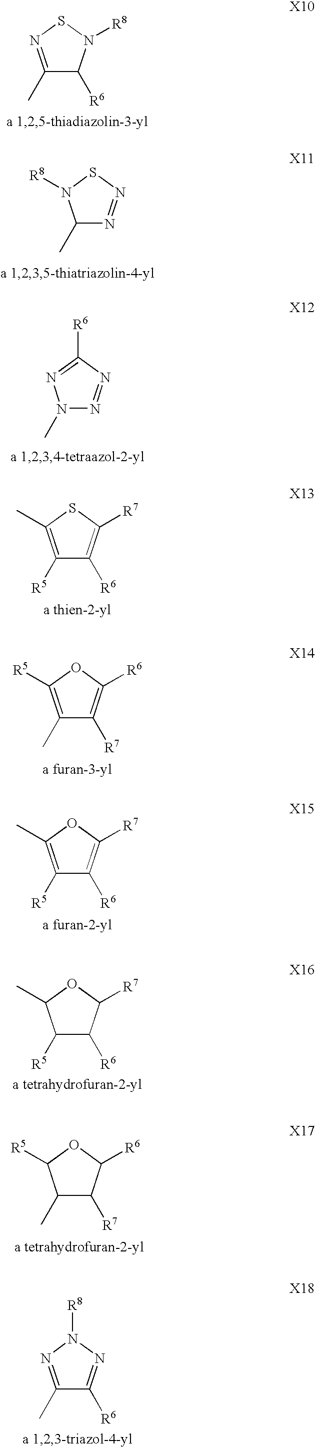 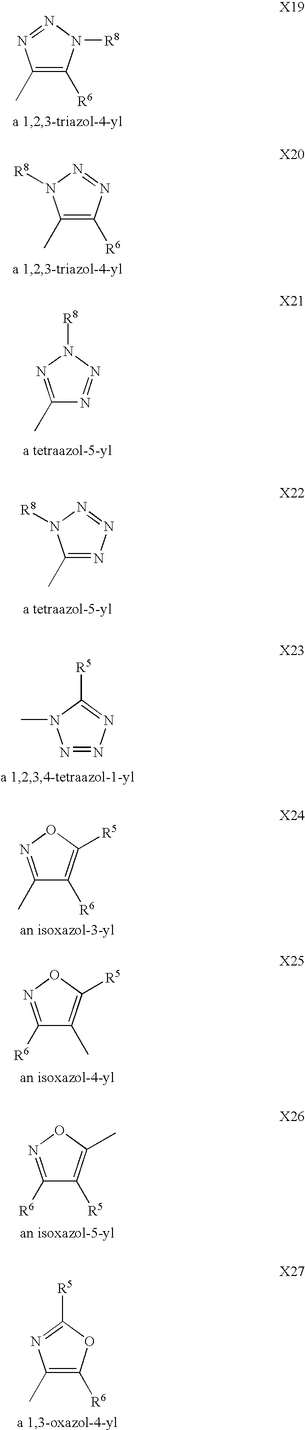 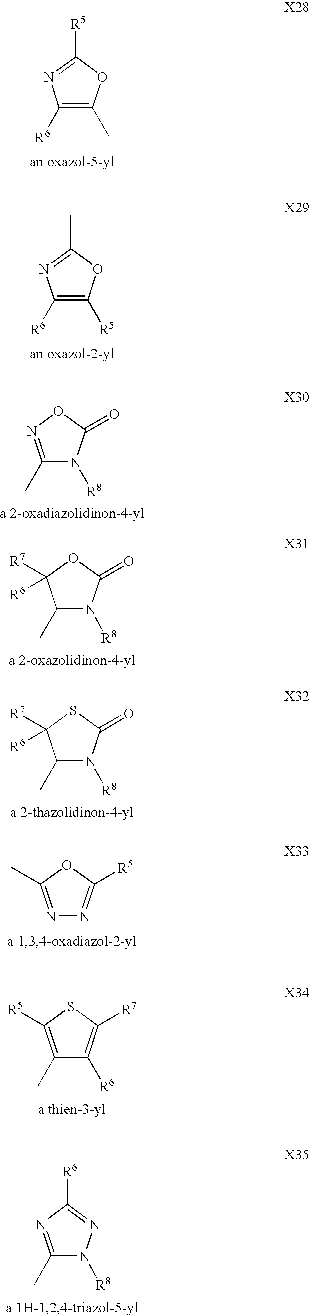
where
R⁵, R⁶ and R⁷ are independently selected from hydrogen; hydroxy; hydroxyalkyl, aminoalkyl, halogen; amino; nitro; alkynyl; haloalkynyl; alkoxy; alkoxyalkyl, haloalkoxy; aryl, arylalkyloxy, alkenyloxy; alkynyloxy; thiol; alkylthio; haloalkylthio; cyanoalkylthio; alkenylthio; alkynylthio; alkoxythio, carboxyl, formyl; alkyloxycarbonyl; carboxyl; —N(R⁹)(R¹⁰); —NHN(R⁹)(R¹⁰); —NHC(O)R⁹; —NHC(O)OR⁹; —OC(O)R⁹; where the aryl may be optionally substituted with halogen, alkyl, haloalkyl, alkoxy, cyano, or haloalkoxy;
where
R⁸ is selected from alkyl, haloalkyl, arylalkyl, alkoxy, alkenyl, haloalkenyl, alkynyl, haloalkynyl,
where
R⁹ and R¹⁰ are independently selected from hydrogen, alkyl, alkenyl, alkynyl, alkylthio, alkylcarbonyl, alkoxycarbonyl, aryl, arylalkyl, and carbonylamino; where the aryl may be optionally substituted with halogen, alkyl, haloalkyl, alkoxy, cyano, or haloalkoxy; and
the corresponding agriculturally acceptable salts thereof.

2. The composition of claim 1, wherein said azacycle R is selected from W1, W3, W4, W8, W13 and W20;
Y and Y¹ are independently selected from hydrogen and halogen;
R¹ is selected from alkyl, haloalkyl, alkoxyalkyl, arylalkyl, alkenyl, haloalkenyl and alkynyl, and
R² is O⁻; forming an N-oxide; and
said 5-membered heterocyle is selected from X2, X4, X6, X8, X12, X18, X33 and X34;
where
R⁵, R⁶ and R⁷ are independently selected from hydrogen; halogen; amino; alkyl, alkenyloxy, haloalkenyloxy, alkynyloxy, haloalkynyloxy, alkoxy, and haloalkoxy.

3. The composition of claim 2, wherein said azacycle R is selected from W1, W3, W4, W8 and W20; Y and Y¹ are hydrogen; R¹ is selected from methyl and ethyl, and said 5-membered heterocyle is selected i) from X2 where R⁵ is hydrogen and X6 where R⁶ is hydrogen; ii) from X4 and X12, where R⁶ is selected from halogen, alkyl and amino; iii) from X8, where R⁶ is hydrogen and R⁸ is selected from alkyl and arylalkyl; iv) from X18, where R⁸ is alkyl; and v) from X34, where R⁵ is hydrogen and R⁶ is alkoxy.

4. The composition of claim 3, wherein said 5-membered heterocyle is selected i) from X2; ii) from X4, where R⁶ is methyl or ethyl; and iii) from X12, where R⁶ is methyl.

5. The composition of claim 4, wherein said azacycle R is W3 and said 5-membered heterocyle is selected i) from X4, where R⁶ is methyl; and ii) from X12.

6. A pesticidal composition comprising a pesticidally effective amount of a compound of formula I in admixture with at least one agriculturally acceptable extender or adjuvant, wherein said compound of formula I is: 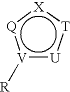
wherein
R is an azacycle selected from the following: 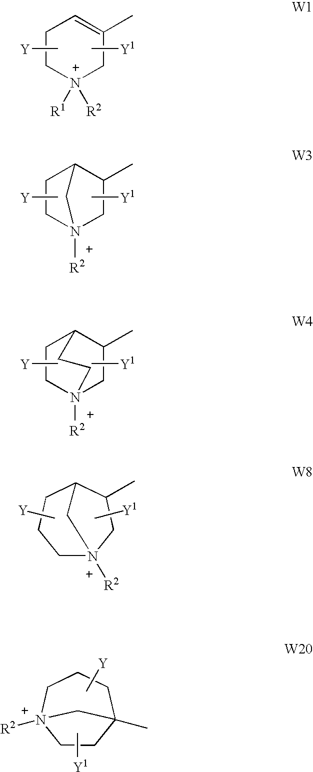
where
Y and Y¹ may be attached at the same or different positions, and are independently selected from hydrogen and halogen;
R¹ is selected from alkyl, haloalkyl, alkoxyalkyl, arylalkyl, alkenyl, haloalkenyl, alkynyl, haloalkynyl, and
R² is O⁻; forming an N-oxide; and 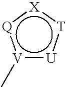
is a 5-membered heterocycle, wherein V is carbon or nitrogen; Q is carbon or nitrogen; X is carbon, nitrogen or sulfur, T is carbon or nitrogen; and U is carbon, nitrogen, oxygen or sulfur, wherein said 5-membered heterocycle is selected from the following; 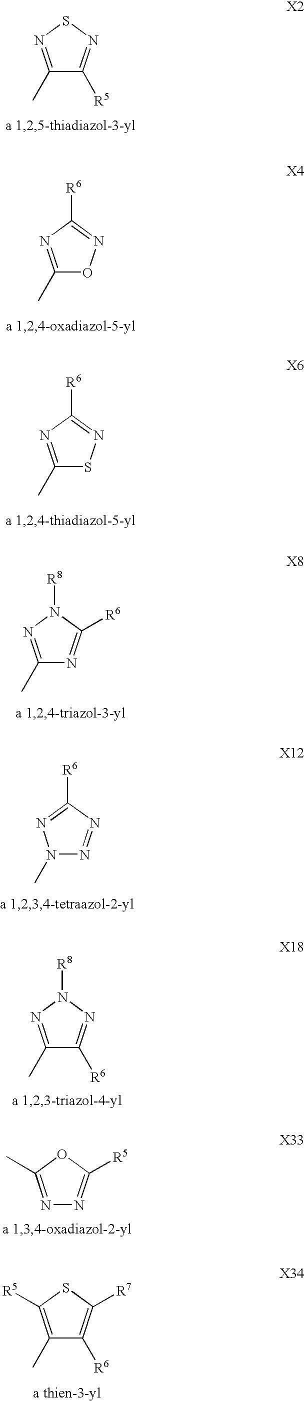
where
R⁵, R⁶ and R⁷ are independently selected from hydrogen; halogen; amino; alkyl, alkoxy, alkenyloxy, and alkynyloxy; and
the corresponding agriculturally acceptable salts thereof.

7. The composition of claim 6, wherein and Y¹ are hydrogen; R¹ is selected from methyl and ethyl and said 5-membered heterocyle is selected i) from X2 where R⁵ is hydrogen and X6 where R⁶ is hydrogen; ii) from X4 and X12, where R⁶ is selected from halogen, alkyl and amino; iii) from X8, where R⁶ is hydrogen and R⁸ is selected from alkyl and arylalkyl; iv) from X18, where R⁸ is alkyl; and v) from X34, where R⁵ is hydrogen and R⁶ is alkoxy.

8. The composition of claim 7, wherein said 5-membered heterocyle is selected i) from X2; ii) from X4, where R⁶ is methyl or ethyl; and iii) from X12, where R⁶ is methyl.

9. The composition of claim 8, wherein said azacycle R is W3 and said 5-membered heterocyle is selected i) from X4, where R⁶ is methyl; and ii) from X12.

10. The composition of claim 1, further comprising one or more second compounds selected from the group consisting of pesticides, plant growth regulators, fertilizers and soil conditioners.

11. A method of controlling insects and acarids, comprising applying an insecticidally and acaricidally effective amount of a composition of claim 1 to a locus where insects and acarids are present or are expected to be present.

12. A method of controlling insects and acarids, comprising applying an insecticidally and acaricidally effective amount of a composition of claim 10 to a locus where insects and acarids are present or are expected to be present.
